(19) United States
(12) Patent Application Publication
(10) Pub. No.: US 2026/0115077 A1
(43) Pub. Date: Apr. 30, 2026

(54) ARM SUPPORT FOR SURGICAL POSITIONING

(71) Applicant: Mizuho Orthopedic Systems, Inc., Union CIty, CA (US)

(72) Inventors: Stephan Schmid, San Francisco, CA (US); Vincent Hodges, San Jose, CA (US); Joshua Wang, Castro Valley, CA (US); Jean-Francois DeBarros, San Francisco, CA (US); Mark Smith, Morgan Hill, CA (US)

(21) Appl. No.: 19/370,591

(22) Filed: Oct. 27, 2025

Related U.S. Application Data
(60) Provisional application No. 63/712,499, filed on Oct. 27, 2024.
(60) Provisional application No. 63/769,459, filed on Mar. 10, 2025.

(51) Int. Cl. A61G 13/12

(52) U.S. Cl. CPC A61G 13/1235; A61G 2200/322

(57) ABSTRACT

An arm board system for a surgery table is provided. The system may include a shoulder arm attached to a table mount, and an arm board attached to the shoulder arm. The shoulder arm may be pitched and yawed with respect to a table mount of the surgery table, and the arm board may independently be translated, pitched, yawed, rolled, and tucked with respect to the shoulder arm.

### RELATED APPLICATION DATA

This application claims priority to U.S. Provisional Application No. 63/712,499, filed Oct. 27, 2024 and U.S. Provisional Application No. 63/769,459, filed Mar. 10, 2025, the disclosures of which are hereby incorporated by reference in their entireties.

### FIELD

This invention relates to medical procedures, and more particularly, to surgery tables used for multiple types of surgeries.

### BACKGROUND

Patient support apparatuses assist in positioning and supporting a patient before, during, and after a medical procedure. Surgery tables are patient support apparatuses used in surgical procedures, and allow a surgeon access to a surgical site and the ability to maneuver, position, or reposition the patient before, during, and after the surgical procedure. Surgeons endeavor to adjust surgery tables while minimizing or preventing risk to the patient. Surgical tables may include a support for an arm of a patient to position the arm during surgery.

### SUMMARY

One or more embodiments may include an arm board system for a surgery table. The arm board system may include an arm board configured to support an arm of a patient. The arm board may have a length, a width, a top surface, and a bottom surface. A joint J1 may be coupled to the bottom surface of the arm board. Joint J1 may include a rod disposed along at least a portion of the length of, and parallel to, the arm board; and a rod mount receiving the rod, and configured to allow the arm board to traverse by selectively permitting the rod to traverse the rod mount. The rod mount may further be configured to allow the arm board to roll on an axis Ala parallel to the length of the arm board by selectively permitting the rod to rotate inside of the rod mount from a horizontal arm board position to one of a first side and a second side. A rotational mount may be coupled to the rod mount. The rotational mount may have a rotational axis A1b perpendicular to a plane parallel to the horizontal arm board position. The rotational mount may be configured to allow the arm board to yaw by selectively permitting the joint J1 to rotate in a direction selected from a first direction and a second direction. A joint J2 may be coupled to joint J1. Joint J2 may have a rotational axis A2 perpendicular to rotational axis A1b of the rotational mount of joint J1, joint J2 and be configured to allow the arm board to pitch on axis A2 from the horizontal arm board position by selectively permitting the joint J2 to rotate in a direction selected from a frontwards direction and a backwards direction. The arm board system may further include a shoulder arm having a length, the shoulder arm coupled to joint J2 at a first end, and a joint J4 at a second end, and configured such that axis A2 of joint J2 is perpendicular to the length of the shoulder arm. The joint J4 may have a rotational axis A4 parallel to the rotational axis A2 of joint J2. Joint J4 may be configured to allow the first end of the shoulder arm to pitch relative to the second end of the shoulder arm from a should arm level position to one of an upwards position and a downwards position. A joint J3 may be coupled to joint J4. Joint J3 may have a rotational axis A3 parallel to the rotational axis A1b of the rotational mount of joint J1. Joint J3 may be configured to allow the first end of the shoulder arm to yaw relative to the second end of the shoulder arm from a proximal position to a distal position. A joint J5 may have a first side and a second side. The first side of joint J5 may be coupled to joint J1 and the second side of joint J5 may be coupled to Joint J2. Joint J5 may have a rotational axis A5 parallel to the rod and offset to a proximal side of the arm board from the rod. Joint J5 may further have a range of motion of approximately 90 degrees and be configured to rotate the arm board and joint J1 from a horizontal arm board position to a tuck position.

Certain embodiments may further include a controller H1 configured to control joint J1 and joint J3, a controller H2 configured to control joint J2 and joint J4, and a controller H3 configured to control joint J5. The arm board may include a controller H1 at one of a first and a second end an may further include a controller H2 at the other of the first end and the second end.

In certain embodiments, H1 is configured to actuate without actuation of H2, and H2 is configured to require actuation of H1 before actuating H2.

In certain embodiments, controller H1 and controller H2 are configured to be actuated by two hands of a user.

In certain embodiments, controller H1 is adjacent to an edge of the bottom surface of the arm board, and controller H2 is adjacent an opposite edge of the bottom surface of the arm board.

In certain embodiments, the arm board and joint J1, joint J2, joint J3, joint J4, and joint J5 do not comprise a ball joint.

In one or more embodiments, an arm board system for a surgery table includes an arm board configured to support an arm of a patient. The arm board may have a length, a width, a top surface, and a bottom surface. The arm board may have at least one first joint configured to allow the arm board to pitch, at least one second joint configured to allow the arm board to yaw, at least one third joint configured to allow the arm board to translate, a controller H1 configured to control the at least one second joint and the at least one third joint, and a controller H2 configured to control the at least one first joint. The arm board may have a controller H1 at one of a first and a second end and may have a controller H2 at the other of the first end and the second end.

In one or more embodiments, an arm board system for a surgery table may include an arm board configured to support an arm of a patient. The arm board may have a length, a width, a top surface, and a bottom surface and be configured to move in at least 2 degrees of freedom. The arm board may have a controller H1 configured to control the arm board in at least 1 of the at least 2 degrees of freedom, and a controller H2 configured to control the arm board in at least the other of the at least 2 degrees of freedom. The arm board may have a controller H1 at one of a first and a second end and a controller H2 at the other of the first end and the second end. Controller H1 and controller H2 may be configured to be actuated by two hands of a user. The arm board may include controller H1 adjacent to an edge of the bottom surface of the arm board, and controller H2 adjacent an opposite edge of the bottoms surface of the arm board.

In one or more embodiments, an arm board system for a surgery table may include an arm board configured to support an arm of a patient. The arm board may have a length, a width, a top surface, and a bottom surface, A joint J2 may be coupled to the bottom surface of the arm board. Joint J2 may include a rotational axis A2 parallel to the width of the arm board in a horizontal arm board position. Joint J2 may be configured to allow the arm board to pitch on axis A2 from the horizontal arm board position by selectively permitting the joint J2 to rotate in a direction selected from a frontwards direction and a backwards direction. The arm board system may further include a shoulder arm having a length, the shoulder arm coupled to joint J2 at a first end, and a joint J4 at a second end, and configured such that axis A2 of joint J2 is perpendicular to the length of the shoulder arm. The arm board and joint J2 may be configured such that the arm board and joint J2 are located distal to a distal plane of the shoulder arm, such that there is no interference between the arm board and joint J2 and the shoulder arm upon rotation of joint J2. Joint J4 may include a rotational axis A4 parallel to the rotational axis of joint J2. Joint J4 may be configured to allow the first end of the shoulder arm to pitch relative to the second end of the shoulder arm. The shoulder arm may be configured such that, when joint J2 and joint J4 pitch in opposite directions, there is no interference between the arm board and joint J2 and the shoulder arm.

In certain embodiments, the shoulder arm is configured such that, when joint J2 and joint J4 pitch in opposite directions, there is no interference between the arm board and joint J2 and the shoulder arm, and further wherein the arm board is configured to remain in a horizontal arm board position throughout a range of motion of joint J2 and joint J4.

In certain embodiments, the bottom surface of the arm board has a proximal half and a distal half. A joint J1 may have a first end and a second end, the first side of joint J1 may be coupled to the proximal half of the bottom surface of the arm board on a first end and further coupled to joint J2 on a second end. Joint J1 may have a rotational mount having a rotational axis Alb perpendicular to a plane parallel to a horizontal arm board position. The rotational mount may be configured to allow the arm board to yaw by selectively permitting the joint J1 to rotate. Joint J1 may have a range of motion of at least 180 degrees from an arm board clearance position to an arm board interference position. The arm board may be configured such that when joint J2 and joint J4 pitch in opposite directions, there is no interference between the arm board and the shoulder arm in the arm board clearance position, and there is interference between the arm board and the shoulder arm in the arm board interference position.

In one or more embodiments, an arm board system for a surgery table may include an arm board configured to support an arm of a patient. The arm board may have a length, a width, a top surface, a bottom surface, and a footprint defined by the arm board width. A joint J1 may be coupled to the bottom surface of the arm board. Joint J1 may include a rod disposed along at least a portion of the length of, and parallel to, the arm board. A rod mount may receive the rod, and be configured to allow the arm board to traverse by selectively permitting the rod to traverse the rod mount. The rod mount may further be configured to allow the arm board to roll on an axis A1a parallel to the length of the arm board, by selectively permitting the rod to rotate inside of the rod mount from a horizontal arm board position. The arm board system may further include a rotational mount having a rotational axis A1b perpendicular to a plane parallel to the horizontal arm board position. The rotational mount may be configured to allow the arm board to yaw by selectively permitting the joint J1 to rotate. Joint J1 may be contained within the footprint of the arm board.

In certain embodiments, the arm board, Joint J1, the rod mount, and rotational mount are not respectively connected by an arm member.

In one or more embodiments, an arm board system for a surgery table includes an arm board configured to support an arm of a patient. The arm board may have a length, a width, a top surface, and a bottom surface. A joint J1 may be coupled to the bottom surface of the arm board. Joint J1 may include a rod disposed along at least a portion of the length of, and parallel to, the arm board; and a rod mount receiving the rod, and configured to allow the arm board to roll on an axis A1a parallel to the length of the arm board, by selectively permitting the rod to rotate inside of the rod mount from a horizontal arm board position to one of a first side and a second side. A joint J5 may be coupled to joint J1. Joint J5 may have a rotational axis A5 parallel to the rod, and offset to a proximal side of the arm board from the rod. Joint J5 may further have a range of motion of about 90 degrees. Joint J5 may be configured to rotate the arm board and joint J1 from a horizontal arm board position to a tuck position.

One or more embodiments may include an arm board system for a surgery table. The arm board system may include an arm board configured to support an arm of a patient and to move in at least 2 degrees of freedom. The arm board system may further include a controller H1 configured to control the arm board in at least 1 of the at least 2 degrees of freedom. The arm board system may further include a controller H2 configured to control the arm board in at least the other of the at least 2 degrees of freedom. The controller H1 may be at one of a first and a second end of the arm board, and the controller H2 at the other of the first end and the second end. The arm board system may further include a locking mechanism configured to alternately actuate the controller H2 and prevent actuation of the controller H2 based on actuation of the controller H1.

In one or more embodiments, the arm board system may further include a first handle configured to pivot to actuate the controller H1. The arm board system may further include a second handle configured to pivot to actuate the controller H2. The locking mechanism may be further configured to alternately allow and prevent the second handle from being pivoted based on actuation of the controller H1 by the first handle. The arm board system may further include a second handle configured to pivot to actuate the controller H2. The locking mechanism may be further configured to alternately allow and prevent the second handle from being pivoted based on actuation of the controller H1 by the first handle.

In one or more embodiments, the arm board system may further include a first joint configured to allow the arm board to yaw. The controller H1 may be further configured to actuate the first joint. The first joint may be further configured to allow the arm board to roll. The arm board system may further include a third joint configured to allow the arm board to yaw. The controller H1 may be further configured to actuate the third joint.

In one or more embodiments, the arm board system may further include a first joint configured to allow the arm board to roll. The controller H1 may be further configured to actuate the first joint.

In one or more embodiments, the arm board system may further include a second joint configured to allow the arm board to pitch. The controller H2 may be further configured to actuate the second joint. The arm board system may further include a fourth joint configured to allow the arm board to pitch. The controller H2 may be further configured to actuate the fourth joint.

In one or more embodiments, the arm board system may further include a fifth joint configured to rotate the arm board to a tuck position. The arm board system may further include a first joint configured to allow the arm board to move in at least one of yaw and roll motions. The fifth joint may be coupled to the first joint. The fifth joint may be further configured to rotate the first joint.

In one or more embodiments, the locking mechanism may include a first link and a second link, the first link coupled to the controller H1 and the second link coupled to the controller H2. The locking mechanism may be configured to prevent actuation of the controller H2 when the first link and the second link are coupled.

In one or more embodiments, the locking mechanism may be configured to allow actuation of the controller H2 when the first link and the second link are uncoupled. Actuation of the controller H1 may be configured to uncouple the first link and the second link. The locking mechanism may further include a latch hook coupled to the first link and a slam latch coupled to the second link. The latch hook and the slam latch may be configured to be coupled to one another such that the first link and the second link are coupled. The latch hook may be configured to uncouple from the slam latch when the first link is pulled. The controller H1 may be configured to pull the first link when actuated. The latch hook may be configured rotate out of the slam latch to uncouple from the slam latch. The latch hook may be configured to couple to slam latch when the first link is released. The controller H1 may be configured to release the first link when unactuated. The latch hook may be configured rotate into the slam latch to couple to the slam latch.

In one or more embodiments, the arm board system may further include an H1 control cable coupled to the controller H1, the H1 control cable configured to unlock one or more first joints configured to be actuated by the controller H1. The arm board system may further include an H2 control cable coupled to the controller H2, the H2 control cable configured to unlock one or more second joints configured to be actuated by the controller H2. The H1 control cable may be coupled to one or more first brake linkages of the one or more first joints. The H1 control cable may be configured to be pulled when the controller H1 is actuated to release the one or more first brake linkages and unlock the one or more first joints. The H2 control cable may be coupled to one or more second brake linkages of the one or more second joints. The H2 control cable may be configured to be pulled when the controller H2 is actuated to release the one or more second brake linkages and unlock the one or more second joints.

In one or more embodiments, the locking mechanism may further include a handle linkage. The locking mechanism may further include a pulley block coupled to the handle linkage and the H2 control cable. The controller H2 may be configured to rotate the handle linkage to move the pulley block and pull the H2 control cable to unlock the one or more second joints. The pulley block may include one or more pulleys. The H2 control cable may be wrapped around the one or more pulleys such that the one or more pulleys is configured to pull the H2 control cable when the one or more pulleys are moved with the pulley block. The pulley block may be coupled to the second link such that the pulley block is configured to be immovable when the second link is coupled to the first link.

In one or more embodiments, the locking mechanism may further include a handle linkage. The locking mechanism may further include a pulley block coupled to the handle linkage and the H1 control cable. The controller H1 may be configured to rotate the handle linkage to move the pulley block and pull the H1 control cable to unlock the one or more first joints. The pulley block comprises one or more pulleys. The H1 control cable may be wrapped around the one or more pulleys such that the one or more pulleys is configured to pull the H1 control cable when the one or more pulleys are moved with the pulley block.

One or more embodiments may include a locking mechanism for an arm board for a surgery table. The locking mechanism may include a first link coupled to a controller H1, the first link extending along a bottom surface of the arm board. The locking mechanism may further include a second link coupled to a controller H2, the second link extending along the bottom surface of the arm board, the controller H1 at one of a first and a second end of the arm board, and the controller H2 at the other of the first end and the second end. The first link may be configured to be coupled to the second link to prevent actuation of the controller H2. The first link may be configured to be uncoupled to the second link to allow actuation of the controller H2

In one embodiment, an arm board system for a surgery table comprises an arm board configured to support an arm of a patient, the arm board comprising a first end, a second end opposing the first end, a distal side, a proximal side opposing the distal side, a top surface, and a bottom surface opposing the top surface, and further comprising at least one first joint configured to allow the arm board to yaw, at least one second joint configured to allow the arm board to vertically pitch, at least one third joint configured to allow the arm board to roll and horizontally translate, a first controller H1 disposed along the bottom surface of the arm board and configured to actuate the at least one first joint and the at least one third joint, the first controller H1 comprising a first handle configured to actuate the first controller H1, a second controller H2 disposed along the bottom surface of the arm board and configured to actuate the at least one second joint, the second controller H2 comprising a second handle configured to actuate the second controller H2, wherein the first controller H1 is configured to be actuated by a first hand of a user and the second controller H2 is configured to be simultaneously actuated by a second hand of the user, and a locking mechanism configured to alternately move between an unlocked position, in which the first controller H1 and the second controller H2 are uncoupled such that the first controller H1 and the second controller H2 do not form a unit, the locking mechanism in the unlocked position configured to allow actuation of the second controller H2, and a locked position, in which the first controller H1 and the second controller H2 are coupled such that the first controller H1 and the second controller H2 form a unit, the locking mechanism in the locked position configured to prevent actuation of the second controller H2 until actuation of the first controller H1.

In certain embodiments, the locking mechanism is further configured to alternately allow and prevent the second handle from being actuated based on actuation of the first controller H1 by the first handle such that the second controller H2 is not actuatable in the locked position of the locking mechanism when the first handle is not actuated and does not actuate the first controller H1, and the second controller H2 is actuatable in the unlocked position of the locking mechanism by the second handle when the first handle is actuated and actuates the first controller H1.

In certain embodiments, the bottom surface comprises a first edge and a second edge opposing the first edge, wherein the first handle is disposed adjacent the first edge, and wherein the second handle is disposed adjacent the second edge.

In certain embodiments, the first controller H1 and second controller H2 are configured to be pivoted.

In certain embodiments, the locking mechanism comprises a first link and a second link, and the first link coupled to the first controller H1 and the second link coupled to the second controller H2, wherein the locking mechanism is configured to prevent actuation of the second controller H2 when the first link and the second link are coupled, wherein actuation of the first controller H1 is configured to uncouple the first link and the second link, and wherein the locking mechanism is configured to allow actuation of the second controller H2 when the first link and the second link are uncoupled.

In certain embodiments, the arm board system further comprises a latch hook coupled to the first link and a slam latch coupled to the second link, wherein the latch hook and the slam latch are configured to be coupled to one another such that the first link and the second link are coupled, wherein the latch hook is configured to uncouple from the slam latch when the first link is pulled, wherein the first controller H1 is configured to pull the first link when actuated wherein the latch hook is configured to couple to slam latch when the first link is released, and wherein the first controller H1 is configured to release the first link when unactuated.

In certain embodiments, the arm board system further comprises a first H1 control cable coupled to the first handle and the one or more first joints, the first control cable configured to unlock the one or more first joints configured to be actuated by the first controller H1.

In certain embodiments, the locking mechanism further comprises a handle linkage and a pulley block coupled to the handle linkage and the first H1 control cable, wherein the first controller H1 is configured to rotate the handle linkage to move the pulley block and pull the first H1 control cable to unlock the one or more first joints, wherein the pulley block comprises one or more pulleys, and wherein the first H1 control cable is wrapped around the one or more pulleys such that the one or more pulleys is configured to pull the first H1 control cable when the one or more pulleys are moved with the pulley block.

In one embodiment, the arm board system further comprises the second joint configured to allow the arm board to vertically pitch about an axis A2, and at least one fourth joint configured to allow the arm board to vertically pitch about an axis A4, and wherein the second controller H2 is further configured to actuate the at least one fourth joint and the at least one second joint.

In certain embodiments, the arm board system further comprises a shoulder arm comprising a first end coupled to the at least one first joint and a second end coupled to the at least one fourth joint, wherein the at least one fourth joint is configured to allow the first end of the shoulder arm to pitch relative to the second end of the shoulder arm such that the arm board vertically pitches.

In certain embodiments, the arm board and the at least one second joint are located distal to a distal plane of the shoulder arm, such that the arm board does not intersect the shoulder arm upon rotation of the arm board about the at least one second joint.

In certain embodiments, when the arm board and the shoulder arm are pitched in opposite directions, the arm board and the shoulder arm do not intersect.

In certain embodiments, the first end, the second end, the distal side, and the proximal side define a footprint of the arm board, and wherein the at least first joint is contained within the footprint of the arm board.

In certain embodiments, the at least one third joint is configured to allow the arm board to tuck such that the arm board is rotatable to about 90 degrees.

In certain embodiments, the first end, the second end, the distal side, and the proximal side define a footprint of the arm board, and wherein the at least one first joint and the at least third joint are coupled together and contained within the footprint of the arm board to provide the yaw, roll, and horizontal translate degrees of freedom.

In another embodiment, an arm board system for a surgery table comprises an arm board configured to support an arm of a patient and to move in at least 2 degrees of freedom, the arm board comprising a longitudinal axis of the arm board, a transverse axis of the arm board, a distal side, a proximal side opposing the distal side, a top surface, a bottom surface opposing the top surface, a first end, and a second end opposing the first end, and further comprising a first controller H1 disposed along the bottom surface and configured to control the arm board in at least 2 of the at least 3 degrees of freedom, the first controller H1 comprising a first handle configured to actuate the first controller H1; a second controller H2 disposed along the bottom surface and configured to control the arm board in at least the other of the at least 3 degrees of freedom, the second controller H2 comprising a second handle configured to actuate the second controller H2; and wherein the first controller H1 is configured to be actuated by a first hand of a user and the second controller H2 is configured to be simultaneously actuated a second hand of the user, and a locking mechanism configured to alternately actuate the second controller H2 and prevent actuation of the second controller H2 based on actuation of the first controller H1, the locking mechanism further configured to alternately allow and prevent the second handle from being actuated based on actuation of the first controller H1 by the first handle such that the second controller H2 is not actuatable when the first handle is not actuated and does not actuate the first controller H1, and the second controller H2 is actuatable by the second handle when the first handle is actuated and actuates the first controller H1.

In certain embodiments, the arm board system further comprises a joint J1 coupled to the bottom surface of the arm board, the joint J1 comprising a rod coupled to the bottom surface of the arm board, the rod extending generally along the longitudinal axis of the arm board, a rod mount comprising a rotational axis A1a generally parallel to the longitudinal axis of the arm board, the rod mount configured to receive the rod, allow the arm board to traverse by selectively permitting the rod to traverse the rod mount, and allow the arm board to roll on the rotational axis A1a by selectively permitting the rod to rotate inside of the rod mount from a first arm board position to one of a first side or a second side such that the arm board is on a different plane and oblique relative to the first arm board position, and a rotational mount coupled to the rod mount, the rotational mount comprising a rotational axis A1b generally perpendicular to a plane parallel to the first arm board position, the rotational mount configured to allow the arm board to yaw on the rotational axis A1b by selectively permitting the arm board to rotate in a direction selected from a first direction or a second direction such that the arm board is on the same plane and oblique relative to the first arm board position, wherein the first controller H1 is configured to actuate the joint J1.

In certain embodiments, the arm board system further comprises a joint J2 coupled to the joint J1, the joint J2 comprising a rotational axis A2 generally perpendicular to the rotational axis A1b of the rotational mount of the joint J1, and configured to allow the arm board to pitch on the rotational axis A2 from the first arm board position by selectively permitting the joint J2 to rotate in a direction selected from a frontwards direction and a backwards direction such that the arm board is on a different plane and oblique relative to the first arm board position, a shoulder arm comprising a first end coupled to the joint J2, a second end, and a longitudinal axis generally perpendicular to the rotational axis A2 of the joint J2, and a joint J4, the second end of the shoulder arm coupled to the joint J4, the joint J4 comprising a rotational axis A4 parallel to the rotational axis A2 of the joint J2, the joint J4 configured to allow the first end of the shoulder arm to pitch on the rotational axis A2 by selectively permitting the first end of the shoulder arm to rotate relative to the second end of the shoulder arm upwards or downwards such that shoulder arm is on a different plane and oblique relative to the first shoulder arm position, wherein the second controller H2 is configured to actuate the joint J2 and the joint J4.

In certain embodiments, the arm board system further comprises a joint J3 coupled to the joint J4, the joint J3 comprising a rotational axis A3 parallel to the rotational axis Alb of the rotational mount of the joint J1, the joint J3 configured to allow the shoulder arm to yaw on the rotational axis A3 by selectively permitting the first end to rotate relative to the second end of the shoulder arm in a direction selected from a first direction or a second direction such that the shoulder arm is on the same plane and oblique relative to the first shoulder arm position wherein the first controller H1 is configured to actuate the joint J3.

In certain embodiments, the joint J3 further comprises a range of motion of approximately 90 degrees, the joint J3 configured to allow the arm board to tuck by selectively permitting the arm board to rotate from the first arm board position such that the arm board is generally perpendicular to the first arm board position.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown. In the drawings:

FIG. 1 shows a perspective view of an arm board system according to an exemplary embodiment.

FIGS. 2A-2E are side views of an arm board system configured to support an arm of a patient in a lateral position according to an exemplary embodiment.

FIGS. 3A-3D are top, side, perspective and side views of an arm board system configured to support an arm of a patient in a supine position according to an exemplary embodiment.

FIGS. 4A-4E are perspective, top, side, perspective and top views of an arm board system configured to support an arm of a patient in a prone position according to an exemplary embodiment.

FIG. 5 shows a perspective view of an arm board system according to an exemplary embodiment.

FIG. 6 shows a bottom view of an arm board system according to an exemplary embodiment.

FIG. 7 is a control diagram of an arm board system according to an exemplary embodiment.

FIG. 8 shows a bottom perspective view of an arm board system according to an exemplary embodiment.

FIG. 9 shows a side view of an arm board system according to an exemplary embodiment.

FIG. 10 shows a detail view of an arm board system according to an exemplary embodiment.

FIG. 11 shows a bottom perspective view of an arm board system according to an exemplary embodiment.

FIG. 12 shows a detail view of an arm board system according to an exemplary embodiment.

FIG. 13 shows a bottom perspective view of an arm board system according to an exemplary embodiment.

FIG. 14 shows a detail view of an arm board system according to an exemplary embodiment.

FIGS. 15A-15B show an arm board system in roll board and tuck positions according to an exemplary embodiment.

FIG. 16 shows accessories for an arm board system according to an exemplary embodiment.

FIG. 17 shows a bottom perspective view of an arm board system according to an exemplary embodiment.

FIG. 18 shows a bottom perspective view of an arm board system according to an exemplary embodiment.

FIG. 19 shows accessories for an arm board system according to an exemplary embodiment.

FIG. 20 shows a detail view of an arm board system according to an exemplary embodiment.

FIG. 21 shows a detail view of an arm board system according to an exemplary embodiment.

FIG. 22 shows a detail view of an arm board system according to an exemplary embodiment.

### DETAILED DESCRIPTION

U.S. patent application Ser. No. ______ filed Oct. 27, 2025 titled “SYSTEMS AND METHODS FOR SURGICAL POSITIONING”, U.S. patent application Ser. No. ______ Filed Oct. 27, 2025 titled SYSTEMS AND METHODS FOR SURGICAL POSITIONING, U.S. patent application Ser. No. ______ Filed October 2027 titled DRAPE FOR USE IN SURGICAL PROCEDURES, U.S. patent application Ser. No. ______ Filed Oct. 27, 2025 titled SYSTEMS AND METHODS FOR SURGICAL POSITIONING, and U.S. patent application Ser. No. ______ Filed Oct. 27, 2025 titled SYSTEMS AND METHODS FOR SURGICAL POSITIONING are hereby incorporated by reference in their entirety.

In the following detailed description of embodiments, reference is made to the accompanying drawings, which form a part hereof and in which are shown, by way of illustration, specific embodiments in which the invention may be practiced. Specific details disclosed herein are in every case a non-limiting embodiment representing concrete ways in which the concepts of the invention may be practiced. This serves to teach one skilled in the art to employ the present invention in virtually any appropriately detailed system, structure or manner consistent with those concepts. It will be seen that various changes and alternatives to the specific described embodiments and the details of those embodiments may be made within the scope of the invention. Because many varying and different embodiments may be made within the scope of the inventive concepts herein described and in the specific embodiments herein detailed without departing from the scope of the present invention, it is to be understood that the details herein are to be interpreted as illustrative and not as limiting.

Patient support apparatuses, such as surgery tables, must position and support a patient for the particular procedure being conducted while minimizing or preventing risk to the patient. In addition, the surgery table may be configured for a surgery in which the arm may be repositioned to facilitate the surgery. The surgery table may include various attachments to support at least a portion of a patient. Embodiments of the present disclosure relate to an arm board system for a surgery table. During a surgical procedure, the arm board system may be mounted to a surgical table in order to support at least a portion of an arm of a patient before, during and after a surgical procedure. In certain embodiments, the arm board system may attach to a side rail of a surgical table.

In one embodiment, the arm board system may include a shoulder arm attached to a table mount, and an arm board attached to the shoulder arm. In another embodiment, the shoulder arm can be pitched and yawed with respect to the table mount, and the board can independently be translated, pitched, yawed, rolled, and tucked with respect to the shoulder arm. In some embodiments, the shoulder arm itself does not translate with respect to the table. In still further embodiments, the arm board system attaches to a side rail of the table, and the arm board is manipulated such that the arm board is at a fixed distance from the table. The shoulder arm may be attached to various tables via table-specific adapters, or a universal adapter that may attach the shoulder arm to a plurality of tables. Reference will now be made to the figures.

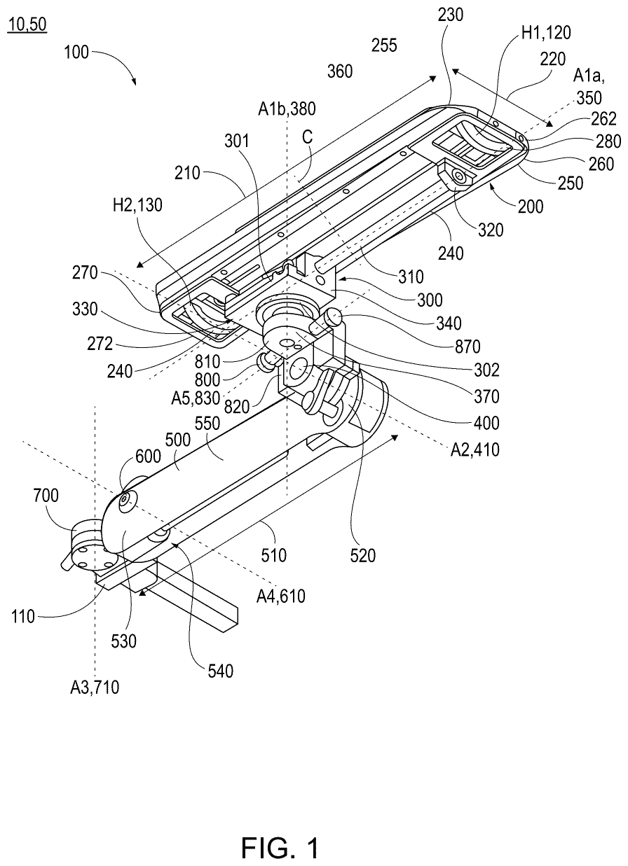

In certain embodiments, with reference to FIG. 1, the arm board system 100 includes an arm board 200. FIG. 1 may show arm board 200 in a neutral position for purposes of description herein.

The arm board 200 may be configured to support an arm of a patient. The arm board 200 may comprise a length 210, a width 220, a top surface 230, a bottom surface 240, a second end 270, a first end 260, a proximal side 250, and a distal side 255. Width 220 may oppose length 210. Bottom surface 240 may oppose top surface 230. First end 260 may oppose second end 270. Distal side 250 may oppose proximal side 255. Length 210 may be the longitudinal span of arm board 200 and comprises a longitudinal axis of arm board 200. Width 220 may be the transverse span of arm board 200 and comprises a transverse axis of arm board 200. In certain embodiments, top surface 230 is configured to support at least a portion of an arm of a patient. In other embodiments, top surface 230 may be flat. In other embodiments, top surface 230 may be substantially flat. In other embodiments, top surface 230 may be concave along length 210 of top surface 230, or along at least a portion of length 210 of top surface 230.

In certain embodiments, arm board system 100 may include a shoulder arm 500 attached to a table mount 110 for a surgical table. In some embodiments, table mount 110 may be a part of a surgical table. Shoulder arm 500 may be attached to table mount 110 via an adapter specific to the table, or a universal adapter that may be attached to a plurality of tables.

In some embodiments arm board system 100 includes a joint J1 300. In some embodiments, arm board 200 may includes joint J1 300 coupled to bottom surface 240 of arm board 200. In some embodiments, joint J1 300 includes a rod 310 disposed along at least a portion of length 210 of arm board 200. Rod 310 may extend along the portion of length 210 such that rod 310 is substantially parallel to distal side 250 and proximal side 255. Rod 310 may have a length, and a first end 320 and a second end 330 opposing first end 320. First end 320 and second end 330 may be mounted to bottom surface 240 of arm board 200.

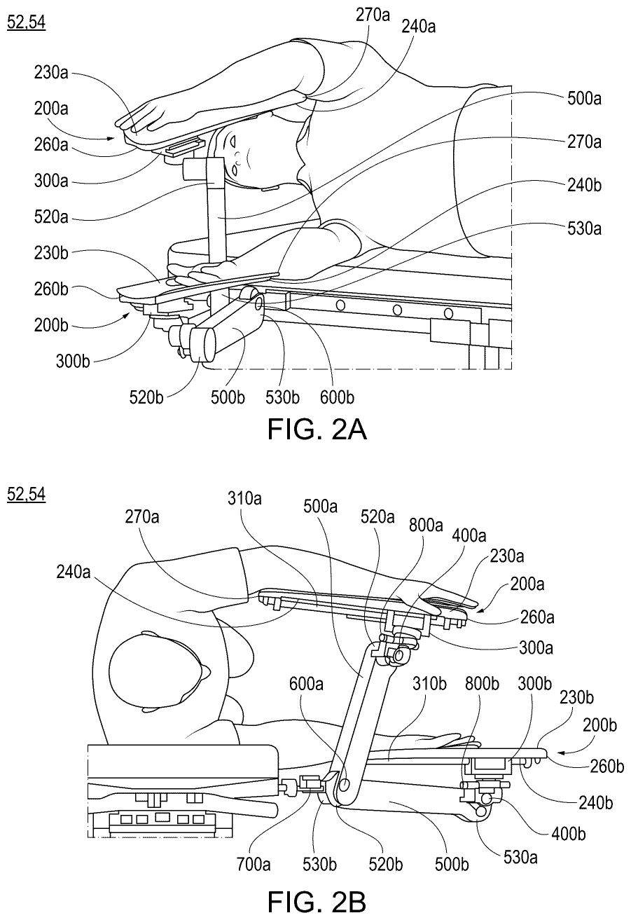

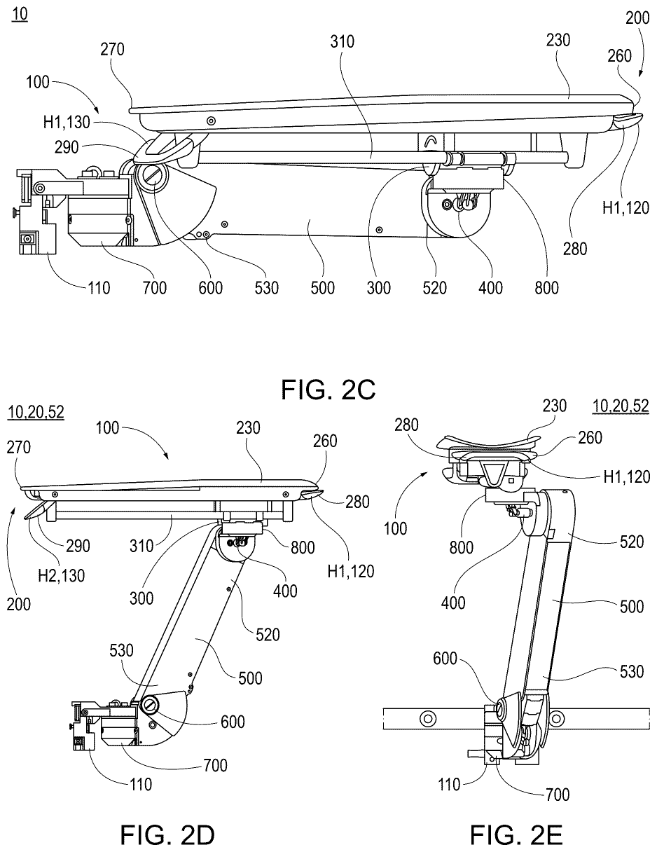

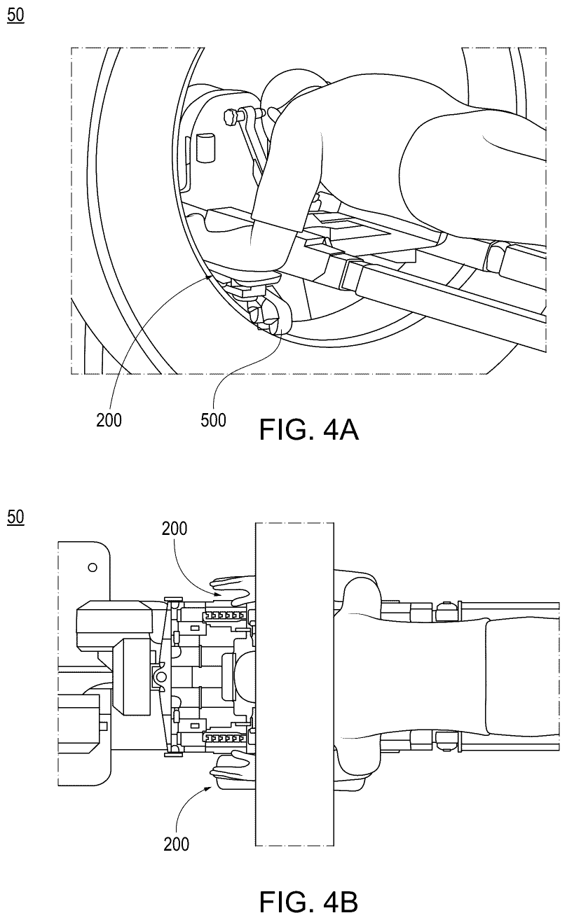

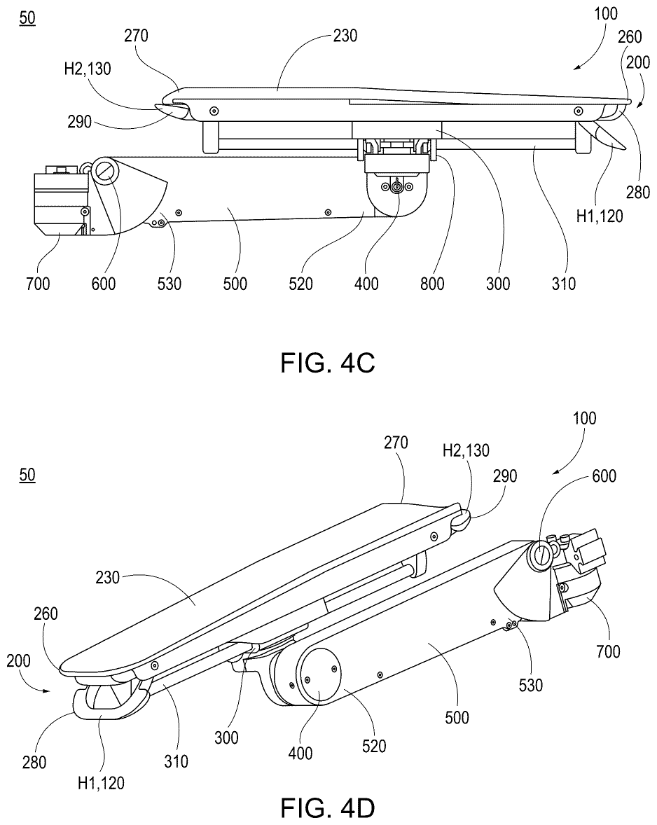

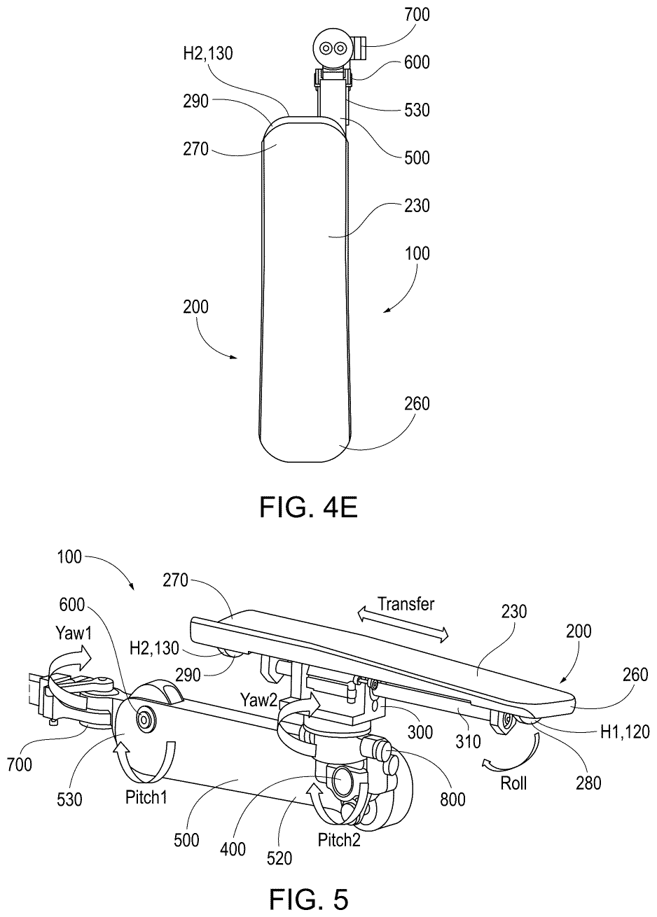

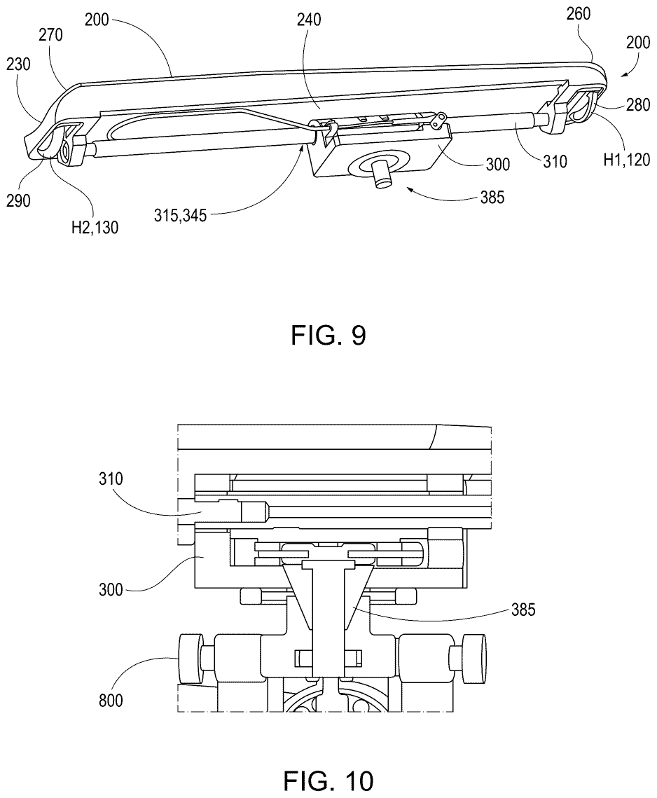

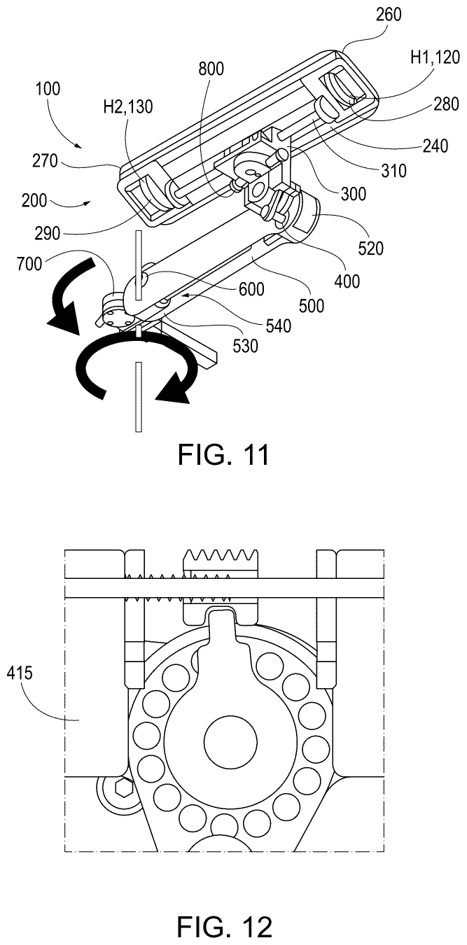

In some embodiments, joint J1 300 may include a rod mount 340 that receives rod 310. In these embodiments, arm board 200 may be traversed by rod 310 allowing rod 310 to selectively traverse the rod mount 340. In this way, arm board 200 may translate. When arm board 200 is positioned such that arm board 200 is generally horizontal relative to the ground, arm board 200 may translate horizontally along rod 310. In some embodiments rod 310 may traverse rod mount 340 between first end 320 and second end 330. FIG. 2C shows rod 310 traversed such that rod mount 340 is near first end 320, and FIG. 4C shows rod 310 traversed such that rod mount 340 is in between first end 320 and second end 330. In other words, arm board 200 can be translated along rod 310 through rod mount 340. In one embodiment, joint J1 300 includes a rod brake 315 (FIG. 9) that, when engaged, may prevent rod 310 from traversing rod mount 340, and fixes rod mount 340 at a particular location between first end 320 and second end 330 until rod brake 315 is released. Another brake may be used as is known in the art. In one embodiment, rod brake 315 includes a cylindrical brake. Arm board 200 is translated and in an arm board translate position 16 such that rod 310 is traversed and rod mount 340 is between first end 320 and second end 330 in FIGS. 4C-D and 8, for example.

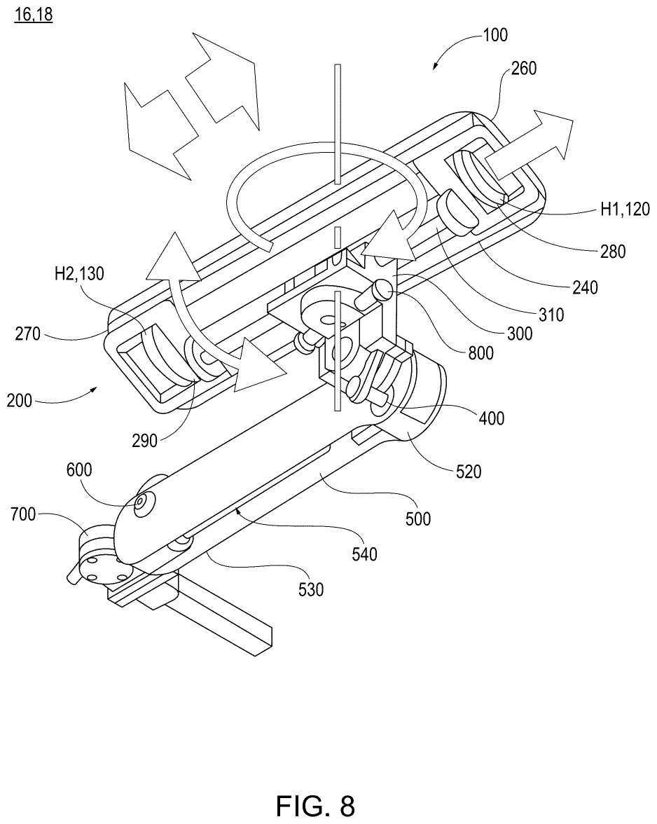

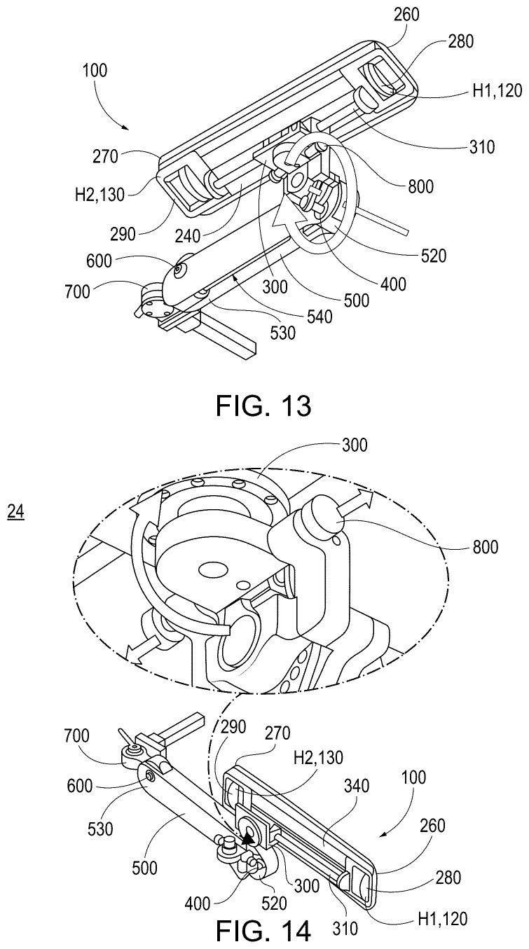

Referring again to FIG. 1, in one embodiment, rod mount 340 is further configured to allow arm board 200 to roll on an axis A1a 350 parallel to length 210 of arm board 200. Arm board 200 may roll to an arm board roll position 18, shown in FIGS. 8, 13, and 15A, for example. Arm board may roll on axis A1a 350 by selectively permitting rod 310 to rotate inside of the rod mount 340 from a horizontal arm board position 10 to one of a first side and a second side. As used herein, horizontal arm board position 10 will refer to the arm board 200 in the neutral position shown in FIG. 1 in which arm board 200 is horizontal. In other words, the plane of the arm board 200 is generally parallel to the ground, or the surface on which the surgical table is supported, or is otherwise generally level. The embodiment of FIG. 8 shows arm board 200 in a first arm board position 12 in which arm board 200 is rolled to a first side. As shown, arm board 200 may appear to be oblique relative to arm board 200 in horizontal arm board position 10, or generally tilted relative to the ground. Accordingly, arm board 200 is on a different plane from the plane containing arm board 200 in horizontal arm board position 10. Arm board 200 in a second arm board position 14 (not shown) involves arm board 200 rolled to a second side, in which arm board 200 may appear to be oblique relative to arm board 200 in horizontal arm board position 10, or generally tilted relative to the ground in the opposite direction.

In one embodiment, rod 310, shown in FIG. 1, may be tubular or have a circular profile, and rod mount 340 includes a tubular channel 360, such that tubular rod 310 may translate and roll inside of tubular channel 360. In other embodiments, rod 310 may have other profiles, including for example square, polygonal, and a geared configuration, and tubular channel 360 is configured to allow rod 310 to translate, and to rotate via mechanical means known to one in the art. In each such embodiment, rod 310 and rod mount 340 are configured to allow arm board 200 to roll about axis A1a 350. In one embodiment, arm board 200 may roll up to about 90 degrees in at least one direction, in another embodiment, arm board may roll up to about 85 degrees 200 in at least one direction, in another embodiment, arm board 200 may roll up to about 45 degrees in either direction, and in another embodiment, at least up to about 30 degrees in either direction. In other embodiments, the range of roll is between at least about 15 degrees and about 30 degrees. In another embodiment, joint J1 300 may include a rod roll brake 345 (FIG. 9) that, when engaged, may prevent rod 310 from rolling inside of rod mount 340, and fixes rod 310 at a particular roll angle until the roll brake 345 is released. Certain embodiments, roll brake 345 includes a cylindrical brake or a gear brake, or a toothed brake for incremental braking. In other embodiments, roll brake is the same brake as rod brake. Another brake may be used as is known in the art.

In certain embodiments, rod 310 is mounted proximal to the bottom surface 240 of arm board 200 such that axis A1a 350 is substantially parallel to, and proximal to top surface 230 of arm board 200. In certain embodiments, axis A1a 350 and the top surface 230 are substantially parallel and separated by about 1 inch, about 1 to about 2 inches, about 1 to about 3 inches, about 2 to about 4 inches, about 1 to about 5 inches, less than about 5 inches, less than about 4 inches, less than about 3 inches, less than about 2 inches, and combinations of any thereof. In this way, the roll axis A1a 350 is as close to the arm of the patient being supported on arm board 200 as possible. In certain embodiments, rolling arm board 200 and/or arm of the patient by rolling the arm board about axis A1a 350 does not substantially displace arm board 200 and/or the arm of the patient laterally from axis A1b 380.

With reference to FIG. 1, in embodiments, joint J1 300 includes a rotational mount 370 coupled to the rod mount 340. The rotational mount 370 may include a rotational axis Alb 380 perpendicular to a plane parallel to arm board position 10. In this way, rotational mount 370 may be configured to allow arm board 200 to yaw on rotational axis A1b 380 to an arm board yaw position 22 (not shown). Arm board 200 may yaw on rotational axis A1b 380 by selectively permitting joint J1 300 to rotate in a direction selected from a first direction and a second direction. In one embodiment, the first direction is clockwise when viewing the arm board 200 in arm board position 10 from above, and the second direction is counter-clockwise when viewing the arm board 200 in horizontal arm board position 10 from above.

In one embodiment, where length 210 of arm board 200 is parallel to shoulder arm 500, joint J1 300 may have a rotational range, or yaw, of about 180 degrees in at least one of the first direction or second direction. In another embodiment, the rotational range is up to about 270 degrees, or up to about 360 degrees. In still a further embodiment, there is no limit to the rotational range and joint J1 300 may spin selectively about rotational axis A1b 380. In another embodiment, joint J1 300 may include a yaw brake 385 (FIG. 10) that, when engaged, may prevent joint rotational mount 370 from yawing about axis A1b 380, and fixes rotational mount 370 at a particular yaw angle until the yaw brake 385 is released. In some embodiments, yaw brake 385 includes a cone brake. Another brake may be used as is known in the art.

Certain embodiments of arm board system 100 include a joint J2 400. In some embodiments, arm board 200 include joint J2 400. Joint J2 400 may be coupled to joint J1 300. As shown in FIG. 1, joint J2 400 may be connected to a bottom side of joint J1 300. Joint J2 400 may include a rotational axis A2 410 perpendicular to rotational axis A1b 380 of the rotational mount 370 of joint J1 300. Joint J2 400 may be configured to allow the arm board 200 to pitch relative to shoulder arm 500 on rotational axis A2 410 from the horizontal arm board position 10. Arm board 200 may be raised to an arm board raised position 20, shown in FIGS. 2D-E, for example, without changing the pitch of arm board 200 by rotating both joint J2 400 and joint J4 600. Arm board 200 may pitch on rotational axis A2 410 by selectively permitting joint J2 400 to rotate in a direction selected from a frontwards direction and a backwards direction. If joint J4 600 is rotated in an equal amount in a direction opposite to joint J2 400, arm board 200 may vertically translate.

As arm board 200 pitches, or vertically translates, via joint J2, arm board 200 may be in a different plane from horizontal arm board position 10 and oblique relative to horizontal arm board position 10, particularly when joint J4 600 remains stationary, or when joint J2 400 does not rotate to the same degree as joint J4 600. In one embodiment, the frontwards direction is clockwise when viewing the arm board 200 in the arm board position 10 from the side as in FIG. 1. Accordingly, as joint J2 400 is rotated, first end 260 of arm board 200 is vertically translated downwards and second end 270 of arm board 200 is vertically translated upwards, and as a whole the arm board 200 pitches forward. The backwards direction is counter-clockwise when viewing the arm board 200 in horizontal arm board position 10 from the side as in FIG. 1. Accordingly, as joint J2 400 is rotated, first end 260 of arm board 200 is vertically translated upwards and second end 270 of arm board 200 is vertically translated downwards. However, arm board 200 may maintain horizontal arm board position 10 when joint J2 400 and joint J4 600 rotate to the same degree in opposite directions.

FIG. 2C shows an embodiment of arm board 200 in horizontal arm board position 10, and joint J2 400, joint J4 600 and shoulder arm 500 are considered to be in a neutral position for reference throughout this disclosure, and joint J2 400 not rotated, and joint J4 600 is not rotated, and shoulder arm 500 is horizontal and not pitched. FIGS. 2D-E shows arm board 200 in horizontal arm board position 10 with joint J2 400 rotated with respect to FIG. 2C such that arm board 200 is in an arm board raised position 20. In raised arm board position 20, joint J2 400 is also rotated with respect to FIG. 2C, and shoulder arm 500 is pitched up relative to FIG. 2C, which will be described further below.

In one embodiment, where length 210 of arm board 200 is parallel to shoulder arm 500, joint J2 400 may have a rotational range of up to about 45 degrees or up to about 90 degrees in at least one of the frontwards direction and backwards direction. In another embodiment, the rotational range is up to about 180 degrees in at least one of the frontwards direction and backwards direction. In still a further embodiment, there is no limit to the rotational range and joint J2 400 may spin selectively about rotational axis A2 410. In another embodiment, joint J2 400 may include a pitch brake 415 that, when engaged, may prevent joint J2 from rotating about axis A2 410, and fixes joint J2 at a particular rotation angle until pitch brake 415 is released. In one embodiment, pitch brake 415 is a pin brake, such as the pin brake shown in FIG. 12. Another brake may be used as is known in the art.

FIG. 8 shows the combined three degrees of freedom of joint J1 300 in translation, roll and yaw, all combined in one joint proximal to bottom surface 240 of arm board 200. In FIG. 8, arm board 200 is translated along rod 310 into arm board translate position 16 such that rod mount 340 is between first end 320 and second end 330. Arm board 200 is also rotated about joint J1 300 to roll on axis A1a 350 into arm board roll position 18.

In certain embodiments, joint J1 300 is mounted proximal to the bottom surface 240 of arm board 200 such that joint J1 300 is proximal to top surface 230 of arm board 200. In certain embodiments, second end 302 of joint J1 300 and top surface 230 are separated by about 1 inch, about 1 to about 2 inches, about 1 to about 3 inches, about 2 to about 4 inches, about 1 to about 5 inches, less than about 6 inches, less than about 5 inches, less than about 4 inches, less than about 3 inches, less than about 2 inches, and combinations of any thereof. In this way, all of the axes of joint J1 300 are as close to the arm of the patient being supported on the arm board 200 as possible. In certain embodiments, rolling, translating or yawing arm board 200 and/or the arm of the patient by rolling, translating or yawing arm board about joint J1 300 does not substantially displace the arm board 200 and/or the arm of the patient laterally from axis A1b 380.

Referring again to FIG. 1, certain embodiments of arm board system 100 include a joint J4 600. In some embodiments, arm board 200 include joint J4 600. In certain embodiments shoulder arm 500 may include a length 510, a first end 520 and a second end 530 opposing first end 520. In one embodiment, shoulder arm 500 may be coupled to joint J2 400 at first end 520, and joint J4 600 at second end 530. In another embodiment, arm board system 100 may be configured such that axis A2 410 of joint J2 400 is perpendicular to length 510 of the shoulder arm 500.

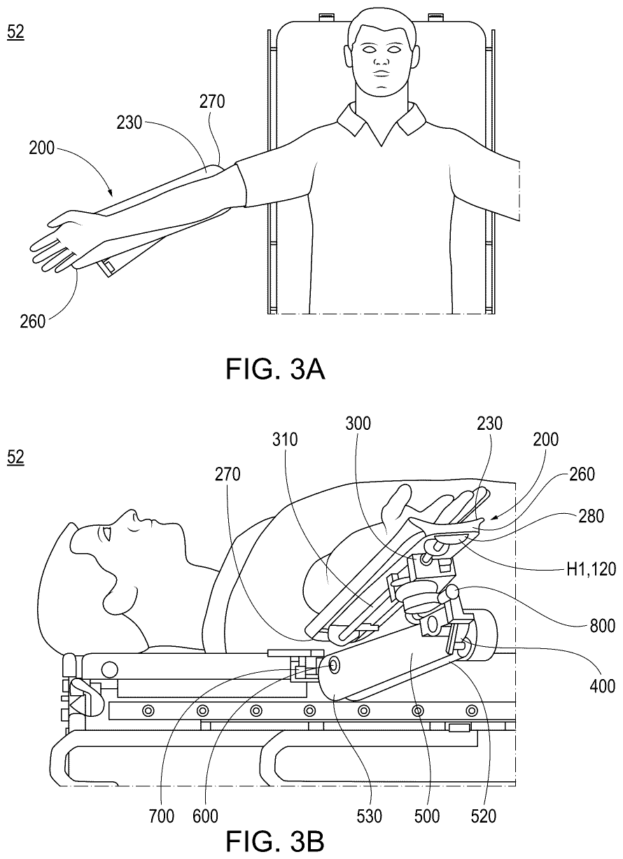

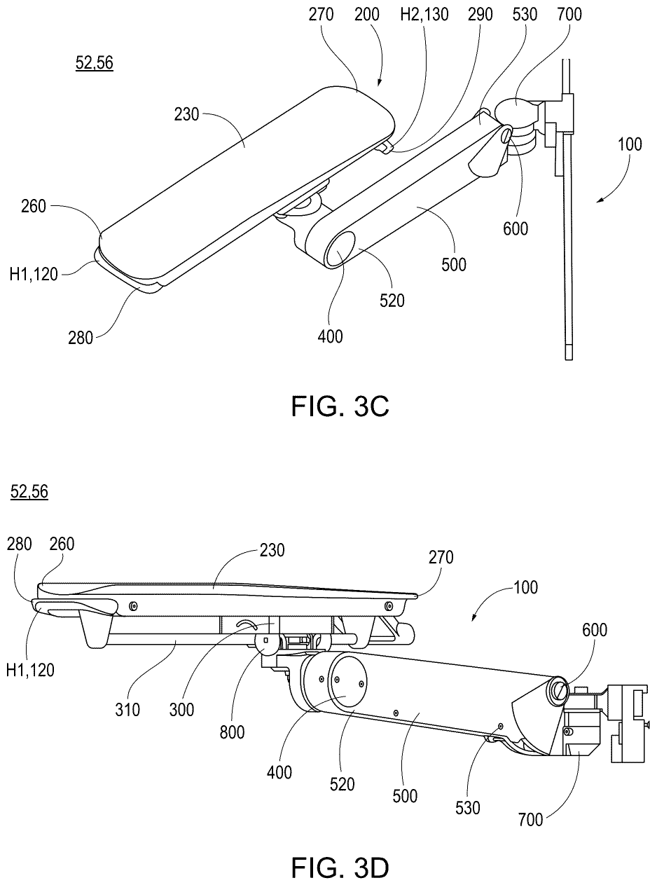

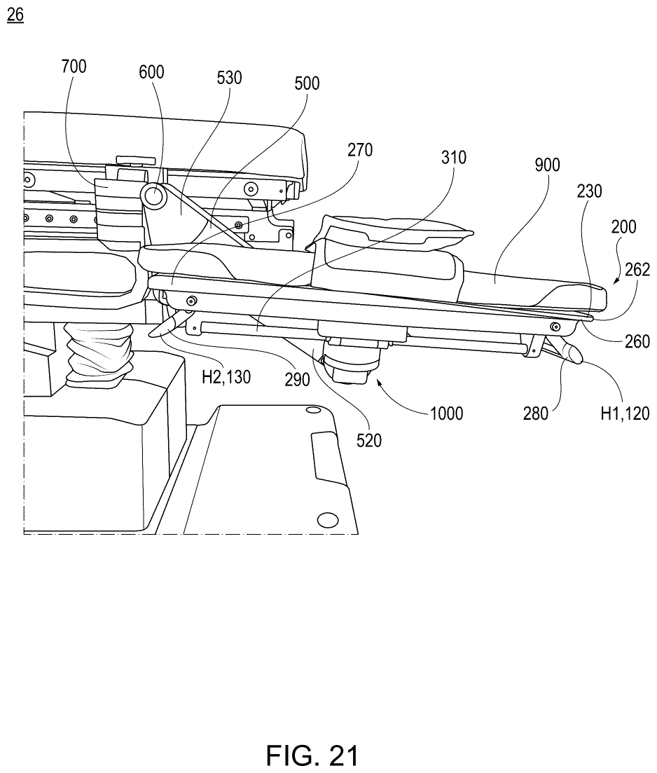

In one embodiment, joint J4 600 may include a rotational axis A4 610 generally parallel to the rotational axis A2 410 of joint J2 400. In one embodiment, joint J4 600 may be configured to allow first end 520 of shoulder arm 500 to pitch relative to second end 530 of shoulder arm 500 from a shoulder arm level position 50, shown in FIG. 1 and FIG. 2C, to one of a shoulder arm raised position 20, 52 (FIGS. 2A-B and 2D-E) and a shoulder arm downwards position 54 (FIGS. 2A-D, 21). FIGS. 2A-B and 2D-E shows a first shoulder arm 500a pitched upwards to almost about 45 degrees in shoulder arm upwards position 52 and a second shoulder arm 500b pitched slightly downwards in shoulder arm downwards position 54 to support a patient laying in a lateral position. FIG. 21 shows shoulder arm 500 pitched slightly downwards in shoulder arm downwards position 54. FIGS. 3A-D show shoulder arm 500 slightly pitched upwards in shoulder arm upwards position 52 to support a patient laying in a supine position. FIG. 4C also shows shoulder arm 500 in shoulder arm level position 50, in which first end 520 and second end 530 of shoulder arm 500 are generally level.

As used herein, shoulder arm upwards position 52 will refer to a position where the first end 520 is pitched above second end 530, and shoulder arm downwards position 54 will refer to a position where first end 520 is pitched below second end 530. In this way, shoulder arm 500 may vertically translate. In one embodiment, joint J4 600 may have a rotational range of up to about 45 degrees in at least one of shoulder arm upwards position 52 or shoulder arm downwards position 54. In another embodiment, the rotational range is up to about 90 degrees in at least one of shoulder arm upwards position 52 or shoulder arm downwards position 54. In still a further embodiment, the rotational range is up to about 120 degrees in at least one of shoulder arm upwards position 52 and shoulder arm downwards position 54. In another embodiment, joint J4 600 may include a shoulder brake 615 (not shown) that, when engaged, may prevent joint J4 600 from rotating about axis A4 610, and fixes joint J4 600 at a particular rotation angle until shoulder brake 615 is released. Another brake may be used as is known in the art.

With reference again to FIG. 1, in certain embodiments, shoulder arm 500 may include a lift assist mechanism 540 that, when shoulder brake 615 and pitch brake 415 are released, applies a force to compensate for the weight of arm board system 100. Accordingly, a user may find it easier to lift and/or lower arm board 200. For example, the user may be able to lift and/or lower arm board 200 without the need of another person. In another example, the user may be able to lift and/or lower arm board 200 with one hand. In certain embodiments, the force substantially compensates for the weight of arm board system 100. In certain embodiments, lift assist mechanism 540 may apply an upwards force to first end 520 of shoulder arm 500 compared to second end 530. In embodiments, lift assist mechanism 415 may include a spring, a gas spring, a motor, and other methods and techniques known in the art.

Certain embodiments of arm board system 100 include a joint J3 700. In some embodiments, arm board 200 include joint J3 700. Joint J3 700 may be coupled to joint J4 600. Joint J3 700 may include a rotational axis A3 710 parallel to the rotational axis A1b 380 of the rotational mount 370 of joint J1 300. Joint J3 700 may be configured to allow first end 520 of shoulder arm 500 to yaw relative to second end 530 of shoulder arm 500 from a proximal position to a distal position. As used herein, a proximal position is one where the arm board 200 is closest to the head of a surgery table, and the distal position is one where the arm board 200 is farthest from the head of a surgery table. First end 520 of shoulder arm 500 may yaw relative to second end 530 of shoulder arm 500 to a shoulder arm yaw position 56 shown in FIGS. 3C-D, for example. In another embodiment, joint J3 700 may include a pivot brake 720 (not shown) that, when engaged, may prevent joint J3 from yawing about axis A3 710, and fixes joint J3 700 at a particular yaw angle until the pivot brake 720 is released. Another brake may be used as is known in the art. As shown in FIGS. 3A-D, joint J3 700 may be rotated to yaw first end 520 of shoulder arm 500 relative to second end 530 of shoulder arm 500, thereby yawing arm board 200.

certain embodiments of arm board system 100 include a joint J5 800, as shown in FIG. 1. In some embodiments, arm board 200 includes joint J5 800. Joint J5 800 may include a first side 810 and a second side 820. In one embodiment, first side 810 of joint J5 800 may be coupled to joint J1 300 and second side 820 of joint J5 800 may be coupled to joint J2 400. The coupling between first side 810 of joint J5 800 and joint J1 300 may be adjacent to the coupling between second side 820 of joint J5 800 and joint J2 400. In this way, arm board 200 coupled to joint J1 300 may be adjacent to shoulder arm 500 coupled to joint J2 400. In other words, arm board 200 may be offset from shoulder arm 500. Accordingly, arm board 200 and shoulder arm 500 may move, or rotate, relative to one another through a larger range of movement while in a compact arrangement.

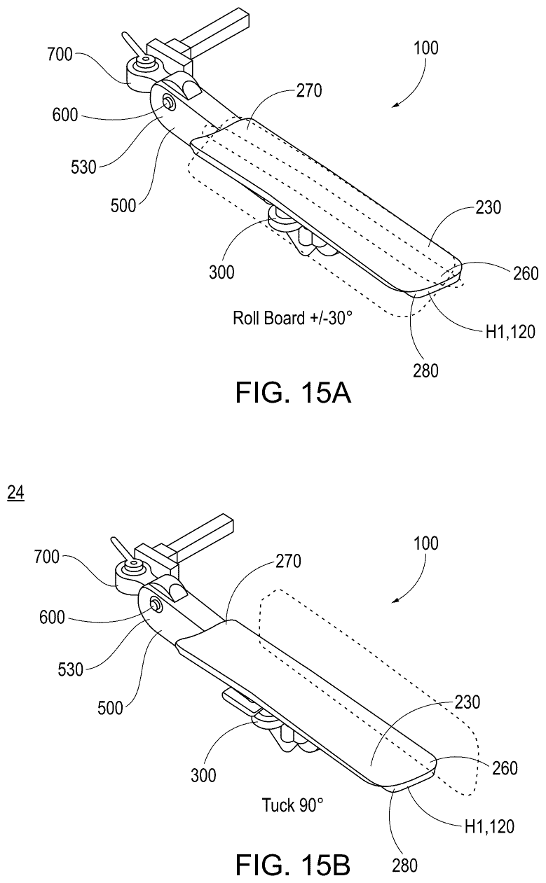

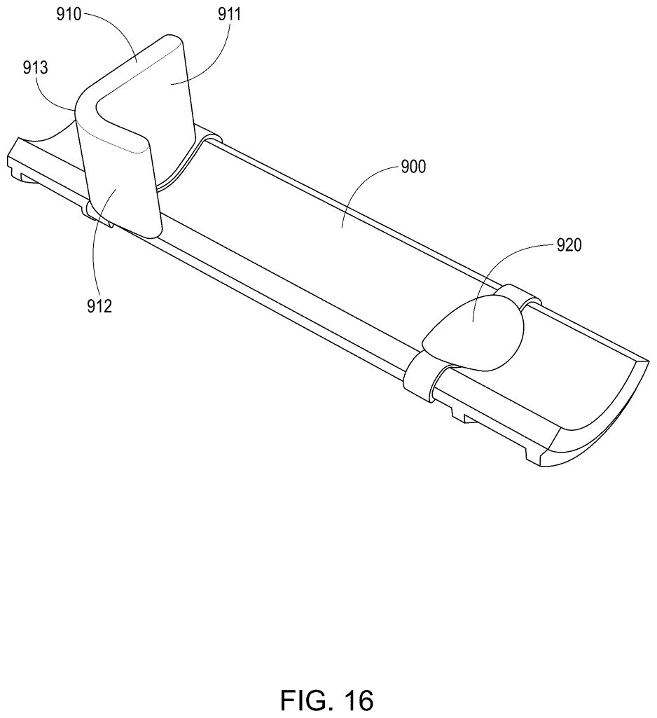

The offset configuration allows for tuck rotation about joint J5 800. Joint J5 800 may include a rotational axis A5 830 parallel to rod 310 and axis A1a 350. In one embodiment, rotational axis A5 830 is offset to proximal side 250 of arm board 200. In another embodiment, rotational axis A5 830 is offset to proximal side 250 of arm board 200 and from rod 310. As used herein, offset to proximal side 250 of arm board 200 means that an item is located on the half of arm board 200 closest to proximal side 250 of arm board 200. In one embodiment, joint J5 800 includes a range of motion of up to approximately 90 degrees about rotational axis A5 to tuck. Arm board 200 may tuck from horizontal arm board position 10 to an arm board tuck position 24, shown in FIGS. 14 and 15B, for example.

In an embodiment in which rotational axis A5 830 is offset to proximal side 250 of arm board 200, arm board 200 may move lower than shoulder arm 500 (like scissors, for example), as shown in FIG. 21 according to exemplary embodiments. In FIG. 21, arm board 200 and shoulder arm 500 are in a scissor position 26. Along with yaw movement, the offset configuration allows for arm board 200 to be positioned offset from shoulder arm 500 (such that arm board 200 travels past shoulder arm 500 like scissors, for example). Each joint is similarly offset to allow relative sliding.

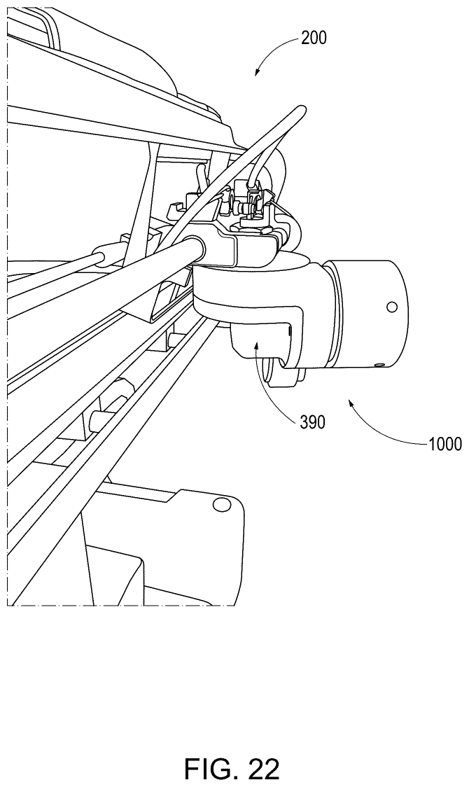

With reference to FIGS. 1 and 21, in some embodiments, a joint 1000 may include joints J1 300, J2 400, and J5 800 is not included, integrating into a single unit joints J1 300, J2 400, and J5 800. Joint 1000 is further shown in FIG. 22. The function of joint J5 800 may be accomplished by placing joint J1 300 at a distal end of joint J2 400, and providing clearance for the arm board to roll up to 90 degrees, or up to 85 degrees, or up to 80 degrees. In certain embodiments, joint J1 300 may be offset from axis A1b 380 to provide the necessary clearance. At the bottom side of joint J1 300, and the sides of joint J1 300, may have cutaway portion 390, allowing arm board 200 to rotate about joint J2 400 while rolled to its maximum roll configuration.

Referring to FIG. 1, in one embodiment, joint J2 400 may be coupled to bottom surface 240 of arm board 200. Rotational axis A2 410 of joint J2 400 may be parallel to width 220 of arm board 200 in horizontal arm board position 10 (FIG. 1), as joint 1000 is positioned in FIG. 21. Joint J2 400 may allow arm board 200 to pitch on axis A2 410 from horizontal arm board position 10 by selectively permitting the joint J2 400 to rotate in a direction selected from a frontwards direction and a backwards direction. Arm board 200 may be rotated about axis A1b 380 such that arm board 200, joint J1 300, joint J2 400, and joint J5 800 are located distal to distal side 550 of shoulder arm 500, such that there is no interference between arm board 200 and joint J2 400 and shoulder arm 500 upon rotation of joint J2 400. As shown in FIG. 21, arm board 200 is adjacent and distal to distal side 550 of shoulder arm 500. Joint J4 600 may be configured to allow first end 520 of shoulder arm 500 to pitch relative to second end 530 of shoulder arm 500. Shoulder arm 500 may be configured such that when joint J2 400 and joint J4 600 rotate in opposite directions, or joint 1000 is actuated in FIG. 21, there is no interference between arm board 200 and shoulder arm 500. When first end 520 of shoulder arm 500 is lowered to arm board 200, if arm board 200 is rotated from this position about axis A1b 380 (e.g., if arm board 200 is yawed), including 180 degrees from this position, arm board 200 may interfere with shoulder arm 500.

In one embodiment, shoulder arm 500 is configured such that, when joint J2 400 and joint J4 600 rotate in opposite directions, there is no interference between arm board 200 and joint J2 400 and shoulder arm 500. Arm board 200 may remain in horizontal arm board position 10, first arm board position 12, or second arm board position 14, throughout a range of motion of joint J2 400 and joint J4 600.

In one embodiment, joint J1 300 includes a first end 301 and a second end 302, the first end 301 of joint J1 300 coupled to proximal side 250 of bottom surface 240 of arm board 200 on first end 301 and further coupled to joint J2 400 on second end 302. Rotational mount 370 of joint J1 300 may be configured to allow arm board 200 to yaw by selectively permitting the joint J1 300 to rotate, joint J1 300 comprising a range of motion of at least 180 degrees from an arm board clearance position to an arm board interference position. Arm board 200 may be configured such that when joint J2 400 and joint J4 600 rotate in opposite directions, there is no interference between arm board 200 and shoulder arm 500 in the arm board clearance position, and there is interference between arm board 200 and shoulder arm 500 in the arm board interference position.

In one embodiment, a footprint is defined by arm board width 220. Rod mount 340 may be configured to allow arm board 200 to traverse by selectively permitting rod 310 to traverse rod mount 340. Rod mount 340 may allow arm board 200 to roll on axis A1a 350 parallel to the length 210 of arm board 200, by selectively permitting rod 310 to rotate inside of rod mount 340 from horizontal arm board position 10. Rotational mount 370 may be configured to allow arm board 200 to yaw by selectively permitting joint J1 300 to rotate such that joint J1 300 is contained within the footprint of arm board 200. In one embodiment, rod mount 340, rod 310, and rotational mount 370 are within the footprint of arm board 200.

In one embodiment, joint J1 300, rod mount 340, and rotational mount 370 are not respectively connected by an arm member. In one embodiment, an arm member includes an arm, or any other body having a length serving to displace one of joint J1 300, rod mount 340, or rotational mount 370 from another such element.

In some embodiments, arm board system 100, arm board 200, joint J1 300, joint J2 400, joint J3 700, joint J4 600, and joint J5 800, alone and in any combination, do not comprise a ball joint.

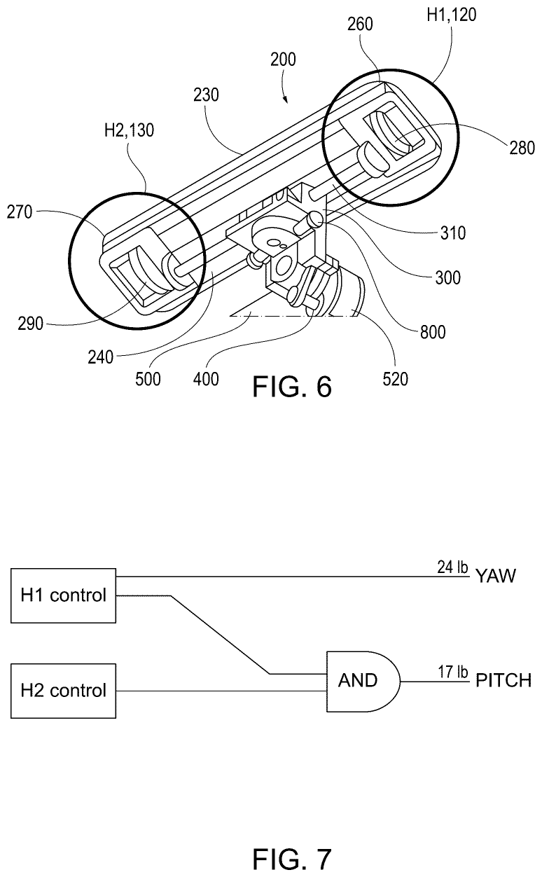

With reference to FIGS. 6-7, in some embodiments, arm board system 100 may further include one or more controllers for controlling the actuation of one or more of joints J1 300, J2 400, J3 700, J4 600 and J5 800. In one embodiment, joints J1 300, J2 400, J3 700, and J4 600 may be controlled via two controllers H1 120, H2 130 of arm board system 100, such as on arm board 200.

A first controller H1 120 and a second controller H2 130 of the two controllers may control, or actuate, one or more of joints J1 300, J2 400, J3 700, J4 600 and J5 800 in order to actuate certain rotations of arm board 200 and/or shoulder arm 500. In one embodiment, first controller H1 120 may provide non-gravity-laden control. Accordingly, first controller H1 120 may control yaw, roll, and translation of joint J1 300 and/or joint J3 700 by releasing one or more of rod brake 315, roll break 345, yaw break 385, and pivot brake 720. In another embodiment, second controller H2 130 of the two controllers may provide gravity laden control. Accordingly, second controller H2 130 may control pitch of arm board 200 by controlling the rotation of joint J2 400 and joint J4 600 by releasing all of pitch brake 415 and shoulder brake 615. As used herein with respect to controller H2, or a controller controlling joint J2 400 and/or joint J4 600, the control of pitch will refer to the control of joint J2 400 and/or joint J4 600, and allowing those joints to rotate. In a further embodiment, controllers H1 120 and H2 130 may control the opposite set of joints. In a still further embodiment, the two controllers H1 120 and H2 130 may be configurable to operate any of the various joints described herein.

Embodiments of arm board system 100 may include any of joints J1 300, J2 400, J3 700, J4 600, J5 800, controllers H1 120, H2 130, and H3 870, and shoulder arm 500, and their respective axes and components, either individually or in any combination thereof. A third controller H3 870, will be described further below.

In one embodiment, first controller H1 120 may be at second end 270 of arm board 200, and second controller H2 130 may be at first end 260 of arm board 200. In certain embodiments, first controller H1 120 and second controller H2 130 may be along bottom surface 240 of arm board 200. As shown in FIG. 1, a centerline C may divide arm board 200. First end 260 may refer to the entire side of arm board 200 across centerline C containing first controller H1 120, or portions thereof. Second end 270 may refer to the entire side of arm board 200 across centerline C containing second controller H2 130, or portions thereof. In further embodiments, first controller H1 120 and second controller H2 130 may be located on or adjacent to centerline C, either across from each other, or on the same side of arm board 200. In another embodiment, first controller H1 120 and second controller H2 130 may be located at opposite sides of arm board 200, but otherwise at any location on arm board 200.

In some embodiments, first controller H1 120 may be configured to actuate without actuation of second controller H2 130, and second controller H2 130 may be configured to require actuation of first controller H1 120 before actuating second controller H2 130. In other embodiments, controllers H1 120 and H2 130 operate independently. Accordingly, second controller H2 130 may actuate with or without actuation of first controller H1 120.

Referring to FIG. 8, in another embodiment, third controller H3 870 may control joint J5 800. Third controller 870 may be located on joint J5 800. In some embodiments, first controller H1 and second controller H2 do not control joint J5.

With reference to FIGS. 6-8, in one embodiment, first controller H1 120 may unlock joints J1 300 and J3 700 for yaw/roll/translation, but not pitch. For example, first controller H1 120 may control the yaw/roll/translate movements shown in FIG. 5. In order to activate pitch via second controller H2 130, second controller H2 130 must also be actuated together with first controller H1 120. Once both controllers H1 120, H2 130 are actuated, then pitch is unlocked. For example, second controller H2 130 may then control the pitch movements shown in FIG. 5.

In some embodiments, first controller H1 120 and second controller H2 130 may be configured to be actuated by a single user. First controller H1 120 and second controller H2 130 may be actuated by two hands of a single user. In some embodiments, each of first controller H1 120 and second controller H2 130 may include a grip or handle 280, 290, as shown in FIGS. 4D, 6, and 8, for example. Each of first controller H1 120 and second controller H2 130 may additionally or alternatively include any other user interface as is known in the art to actuate the one or more joints, e.g., a push button, toggle switch, slider switch, etc.

Each of the first controller H1 120 and second controller H2 130 may be actuated by movement of the respective grip or handle 280, 290 by separate hands of a user. In embodiments, handles 280, 290 may be disposed on arm board 200 so that the manipulation of the arm of the patient is more natural, for example, the hands of the user are proximal to the arm of the patient being moved, compared to a remote control or locking and unlocking mechanical joints individually farther away from the arm (and likely requiring another person to support the arm board while the joint is being locked/unlocked/manipulated). In other words, embodiments herein allow for control of pitch, roll, translation, and yaw proximate arm board 200 rather than remotely from arm board 200.

As shown in FIG. 1, arm board 200 may include a first edge 262 of bottom surface 240 and a second edge 272 opposing first edge 262 of bottom surface 240 of arm board 200. In some embodiments, first controller H1 120 may be adjacent to first edge 262. First edge 262 may be on first end 260 of arm board 200. First edge 262 may be the terminal portion of first end 260. Second controller H2 130 may be adjacent a second edge 272. Second edge 272 may be on second end 270 of arm board 200. Second edge 272 may be the terminal portion of second end 270. In this way, a user may grasp opposing edges 262, 272 of arm board 200 while simultaneously gripping and manipulating first controller H1 120 and second controller H2 130.

In some embodiments, at least one first joint may be configured to allow arm board 200 to pitch, at least one second joint may be configured to allow arm board 200 to yaw, and at least one third joint may be configured to allow arm board 200 to translate. First controller H1 120 may be configured to control the at least one second joint and the at least one third joint. Second controller H2 130 may be configured to control the at least one first joint.

In some embodiments, arm board 200 may be configured to move in at least 2 degrees of freedom, such as at least 3 degrees of freedom. First controller H1 120 may be configured to control arm board 200 in at least 1 of the at least 2 degrees of freedom, such as at least 2 of the at least 3 degrees of freedom. Second controller H2 130 may be configured to control arm board 200 in at least the other degrees of freedom, such as the other of the at least 2 degrees of freedom, or the other of the at least 3 degrees of freedom.

FIGS. 2A-4E show surgical tables having arm boards configured to support the arms of the patient in various positions, such as lateral (FIGS. 2A-2E), supine (FIGS. 3A-3D), and prone (FIGS. 4A-4E).

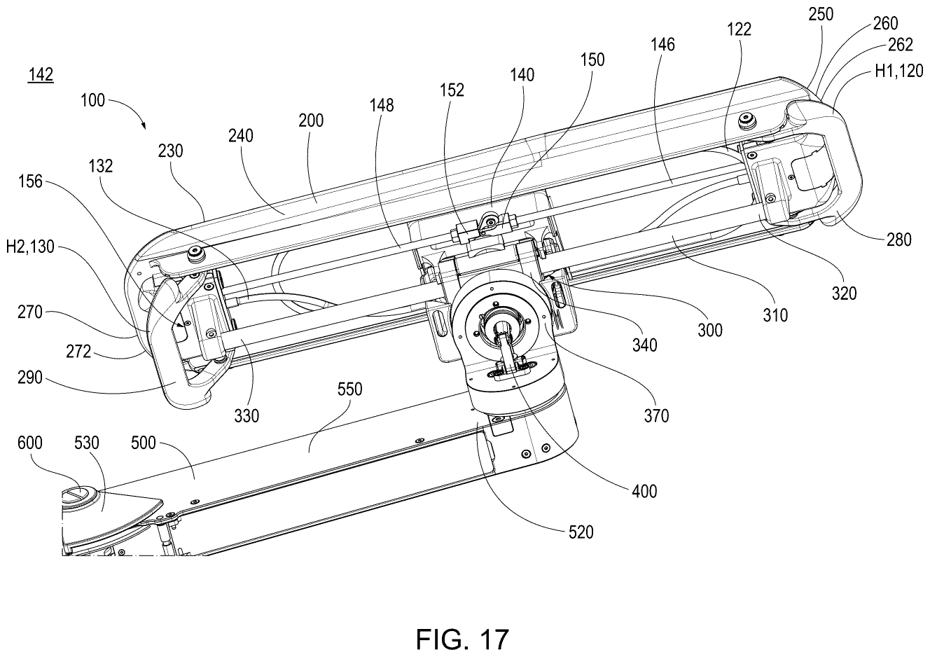

In certain embodiments, with reference to FIG. 17, arm board system 100 may include a locking mechanism 140. Locking mechanism 140 may alternately allow actuation of second controller H2 130 and prevent actuation of second controller H2 130 until actuation of first controller H1 120. Locking mechanism 140 may be disposed substantially along bottom surface 240 of arm board 200.

As discussed, embodiments of arm board 200 may include handle 280. Handle 280 may pivot, or be depressed or otherwise moved, to actuate first controller H1 120. Arm board 200 may also include handle 290. Handle 290 may pivot, or be depressed or otherwise moved, to actuate second controller H2 130. Locking mechanism 140 may alternately allow and prevent handle 290 from being pivoted based on actuation of first controller H1 120 by handle 280. In other words, handle 290 may be pivotable only when handle 280 has been pivoted, or second controller H2 130 may be actuatable only when first controller H1 120 is actuated. In this way, first controller H1 120 and handle 280 may act as a safety, as motion controlled by second controller H2 130 may be prevented until first controller H1 120 is actuated by pivoting handle 280. Further, second controller H2 130 may be actuated only when two hands of a user are on arm board 200, and when two hands of the user are pivoting handle 280 and handle 290. The two-handed operation requirement may provide better control of arm board 200 and safe operation during motions allowed by second controller H2 130. In this manner, in embodiments where second controller H2 130 controls pitch, the pitch function will not be released until the board is supported by both hands of a user, one at each of first controller H1 120 and second controller H2 130, so that the user does not inadvertently lose pitch control of the arm board 200.

As discussed, with reference to FIGS. 1 and 17, in some embodiments, arm board 200 may include joint J1 300. Joint J1 300 may allow arm board 200 to yaw. First controller H1 120 may actuate joint J1 300. Additionally or alternatively, joint J1 300 may allow arm board 200 to roll. Additionally or alternatively, arm board 200 may include joint J3 700 (FIG. 1). Joint J3 700 may allow arm board 200 to yaw. First controller H1 120 may actuate joint J3 700. Additionally or alternatively, arm board 200 may include joint J2 400. Joint J2 400 may allow arm board 200 to pitch. Second control H2 130 may actuate joint J2 400. Additionally or alternatively, arm board 200 may include joint J4 600. Joint J4 600 may allow arm board 200 to pitch. Second control H2 130 may actuate joint J4 600. Additionally or alternatively, arm board 200 may include joint J5 800 (FIG. 1). Joint J5 800 may rotate arm board 200 to a tuck position. Joint J5 800 may be coupled to joint J1 300. Accordingly, joint J5 800 may also rotate joint J1 300.

In some embodiments, locking mechanism 140 may alternately lock and release joint J1 300, joint J2 400, joint J3 700 (FIG. 1), and joint J4 600 via first controller H1 120 and second controller H2 130. First controller H1 120 may alternately lock and release joint J1 300 and joint J3 700. Second controller H2 130 may lock and release joint J2 400 and joint J4 600. However, second controller H2 130 may only lock and release joint J2 400 and joint J4 600 when first controller H1 120 is actuated.

First controller H1 120 and second controller H2 130 may be releasably coupled to one another via locking mechanism 140 by any means known in the art. As shown in FIG. 17, one embodiment of locking mechanism 140 may include a first link 146 and a second link 148. First link 146 may be positioned generally in first end 260 of arm board 200, which may support at least a hand of a patient. First link 146 may be coupled to first controller H1 120. Second link 148 may be positioned generally in second end 270, which may support at least an elbow of a patient. Second link 148 may be coupled to second controller H2 130. Locking mechanism 130 may prevent actuation of second controller H2 130 when first link 146 and second link 148 are coupled. Accordingly, joint J2 400 and joint J4 600 may be locked and may not be released when first link 146 and second link 148 are coupled.

In certain embodiments, locking mechanism 140 is in a locked position 144 (not shown) when first link 146 and second link 148 are coupled. With reference to FIGS. 17-19 according to embodiments, locking mechanism 140 is in an unlocked position 142.

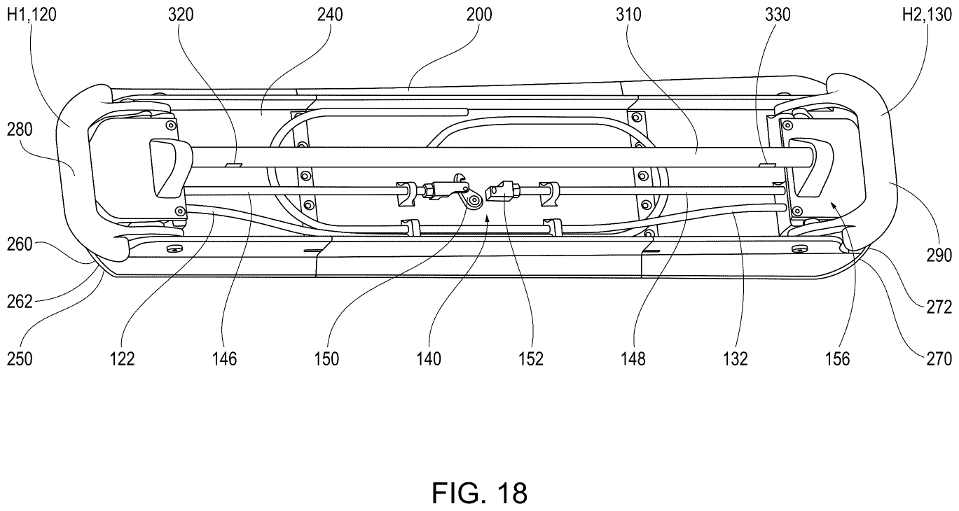

With reference to FIG. 18, in some embodiments, locking mechanism 140 may allow actuation of second controller H2 130 when first link 146 and second link 148 are uncoupled. Actuation of first controller H1 120 may uncouple first link 146 and second link 148. As shown, first link 146 and second link 148 are uncoupled such that first link 146 and second link 148 do not form a unit. Accordingly, first controller H1 120 coupled to first link 146 and second controller H2 130 coupled to second link 148 may be independently actuated. In other words, first controller H1 120 and second controller H2 130 are uncoupled such that each may be independently actuated. In contrast, in locked position 144 (not shown) first link 146 and second link 148 are coupled such that first link 146 and second link 148 form a unit. Accordingly, second controller H2 130 may not independently be actuated unless and until first controller H1 120 is activated.

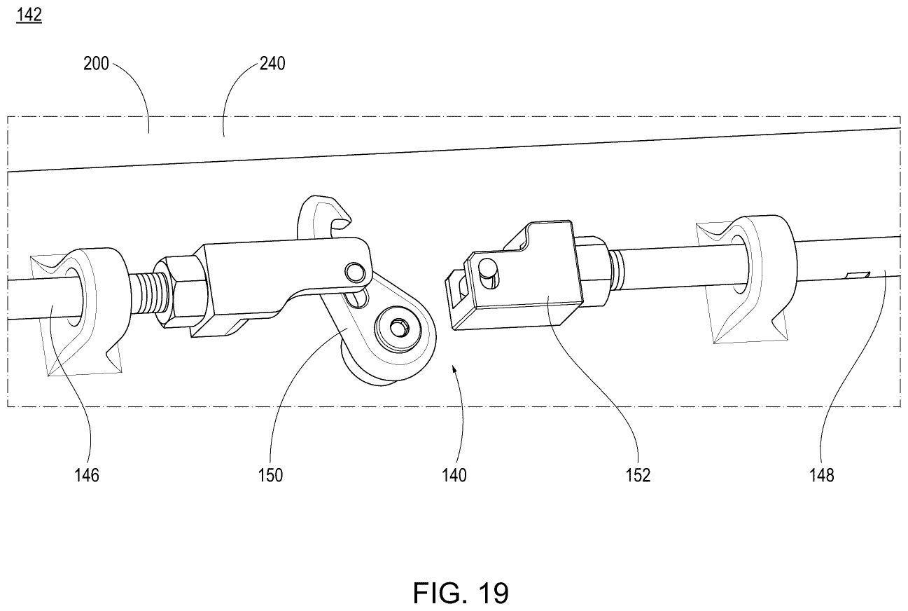

First link 146 and second link 148 may be coupled by any releasable coupling means known in the art. In one embodiment, locking mechanism 140 may include a latch hook 150, as best shown in FIG. 19. Latch hook 150 may be coupled to first link 146. Locking mechanism 140 may also include a slam latch 152. Slam latch 152 may be coupled to second link 148. Latch hook 150 and slam latch 152 may be coupled to one another such that first link 146 and second link 148 are coupled. Latch hook 150 and slam latch 152 may be uncoupled from one another such that first link 146 and second link 148 are uncoupled. In this way, locking mechanism may be in unlocked position 142.

Latch hook 150 may uncouple from slam latch 152 when first link 146 is pulled. First controller H1 120 may pull first link 146 when actuated. Accordingly, latch hook 150 may uncouple from slam latch 152. Slam latch 152 may include a cavity to receive at least a portion of latch hook 150 when latch hook 150 and slam latch 152 are coupled. Latch hook 150 may rotate out of slam latch 152 to uncouple from slam latch 152.

Latch hook 150 may couple to slam latch 152 when first link 146 is released. Accordingly, first link 146 is not pulled. First link 146 may not be pulled when first controller H1 120 and second controller H2 130 are coupled. First controller H1 120 may release first link 146 when unactuated. Accordingly, latch hook 150 may couple to slam latch 152. Latch hook 150 may rotate into slam latch 152 to couple to slam latch 152.

Arm board 200 may include components to facilitate alternately locking and releasing joint J1 300, joint J2 400, joint J3 700 (FIG. 1), and joint J4 600 via first controller H1 120 and second controller H2 130. Referring again to FIG. 18, arm board 200 may include a first H1 control cable 122. First H1 control cable 122 may be coupled to first controller H1 120. First H1 control cable 122 may unlock one or more joints that may be actuated by first controller H1 120. Accordingly, first H1 control cable 122 may be coupled to at least one of joint J1 300 (FIG. 17) or joint J3 700 (FIG. 17) such that first H1 control cable 122 may unlock joint J1 300 and joint J3 700, which may be unlocked by first controller H1 120. H1 control cable 122 may be coupled to one or more brake linkages (not shown) of one or more joints that may be actuated by first controller H1 120. Accordingly, first H1 control cable 122 may be pulled when first controller H1 120 is actuated to release the one or more first brake linkages and unlock the one or more joints that may be actuated by first controller H1 120.

Arm board 200 may include a second H2 control cable 132. second H2 control cable 132 may be coupled to second controller H2 130. second H2 control cable 132 may unlock one or more joints that may be actuated by second controller H2 130. Accordingly, second H2 control cable 132 may be coupled to at least one of joint J2 400 (FIG. 17) or joint J4 600 (FIG. 17) such that second H2 control cable 132 may unlock joint J2 400 and joint J4 600, which may be unlocked by second controller H2 130. second H2 control cable 132 may be coupled to one or more brake linkages (not shown) of one or more joints that may be actuated by second controller H2 130. Accordingly, second H2 control cable 132 may be pulled when second controller H2 130 is actuated to release the one or more first brake linkages and unlock the one or more joints that may be actuated by second controller H2 130.

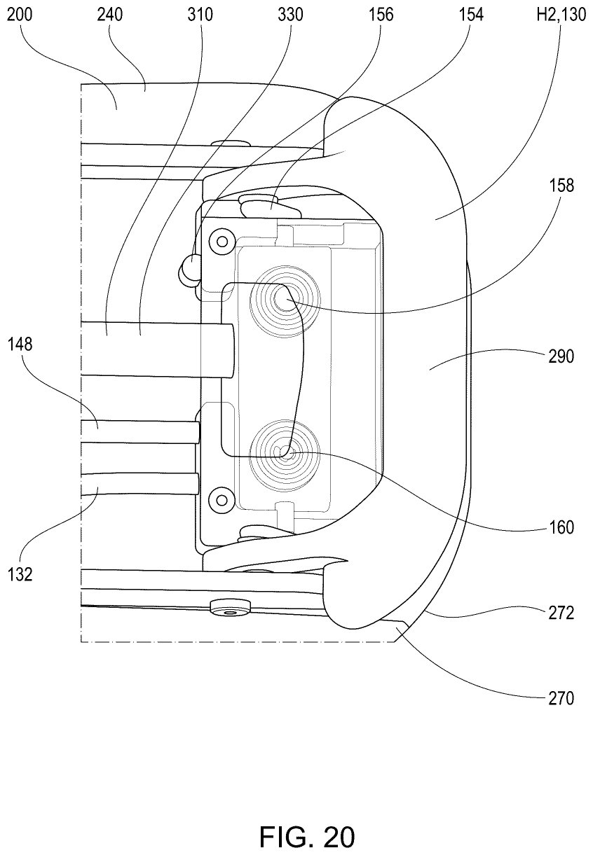

In some embodiments, additional components of locking mechanism 140 to unlock the one or more joints that may be actuated by second controller H2 130 are shown in FIG. 20. While reference is made to unlocking the one or more joints that may be actuated by second controller H2 130, similar components may be incorporated in arm board 200 to unlock the one or more joints that may be actuated by first controller H1 120 (FIG. 19), such as along first end 260 (FIG. 18) of arm board 200.

Referring to the embodiment shown in FIG. 20, locking mechanism 140 may include a handle linkage 154. Locking mechanism 140 may include a pulley block 156 coupled to handle linkage 154 and second H2 control cable 132 (FIG. 18). Second controller H2 130 may rotate handle linkage 154 to move pulley block 156 and pull second H2 control cable 132 to unlock one or more joints that may be actuated by second controller H2 130. Pulley block 156 may pull second H2 control cable 132 via one or more pulleys. As shown, pulley block 156 may include one or more pulleys. For example, pulley block 156 may include a first pulley 158 and a second pulley 160. second H2 control cable 132 may be wrapped around the one or more pulleys, such as around first pulley 158 and second pulley 160. Accordingly, the one or more pulleys, such as first pulley 158 and second pulley 160, may pull second H2 control cable 132 when the one or more pulleys are moved with pulley block 156.

Pulling second H2 control cable 132 may cause second H2 control cable 132 to be, actuated, such as pulled or stretched. second H2 control cable 132 may be actuated about half the distance of the rotation of handle 290. First pulley 158 and second pulley 160 may cause the amount of actuation of second H2 control cable 132. Accordingly, including fewer pulleys may lower the amount of actuation. Including additional pulleys may increase the amount of actuation. The pulling of second H2 control cable 132 by the one or more pulleys may create a mechanical advantage to lower the force necessary to rotate handle 290 and unlock the one or more joints that may be actuated by second controller H2 130. One of ordinary skill in the art will recognize that there are other methods for creating a force advantage that may be employed, including other mechanical means using gears, hydraulics, or pneumatics, and electromechanical means.

second H2 control cable 132 may be released, or not pulled, when pulley block 156 is no longer moved. Accordingly, the one or more joints that may be actuated by second controller H2 130 is locked. Releasing second H2 control cable 132 may allow the one or more brake linkages (not shown) of one or more joints that may be actuated by second controller H2 130 to release such that the one or more brake linkages lock the one or more joints. As shown in FIG. 20, pulley block 156 may be coupled to second link 148 such that pulley block 156 is immovable when second link 148 is coupled to first link 146. As discussed, second link 148 is coupled to first link 146 when first controller H1 120 is unactuated.

With reference to FIGS. 17-20, one of ordinary skill in the art will recognize that there are other methods for interlocking the controls for first controller H1 120 and second controller H2 130, including other mechanical interlocks, electromechanical interlocks, hydraulics, pneumatics, and other systems.

FIG. 16 shows an embodiment of arm board system 100 including certain accessories. In one embodiment, arm board system 100 may include padding 900. In one embodiment, padding may cover at least a portion of, or all of, the top surface 230 of arm board 200 including its length 210, width 220, from first end 260 to second end 270. In some embodiments, padding 900 may only cover the portion of arm board 200 that supports the patient's arm. In certain embodiments, padding 900 follows the contours of top surface 230, for example, if top surface 230 is flat, substantially flat, or concave along its length. In some embodiments, arm board system 100 may include an elbow pad 910. Elbow pad 910 may be located proximate to the elbow of a patient's arm that is being supported by arm board system 100. In certain embodiments, elbow pad 910 does not support the arm of a patient, but protects the arm of a patient from interference with other equipment and/or people before, during or after a surgical procedure. In embodiments, elbow pad may include upper arm portion 911, which may be proximate to a portion of the upper arm of a patient, and lower arm portion 912, which may be proximate to a portion of the lower arm of a patient, and elbow portion 913 proximate the elbow of a patient. In still further embodiments, arm board system 100 may include wrist support 920. In one embodiment wrist support 920 may be configured to be placed in a hand of a patient in order to configure the wrist of a patient in a neutral angle or position. In another embodiment, wrist support 920 may be shaped to substantially fill the space under a patient's hand when a patient's arm is in a neutral position. In certain embodiments, wrist support 920 may include a width greater than its length. In other embodiments, wrist support 920 may follow the contours of top surface 230, for example, if top surface 230 is flat, substantially flat, or concave along its length. Embodiments of padding 900, elbow pad 910 and wrist support 920 may be used individually or in combination, and may be used with arm board system 100, or other arm supports not disclosed herein.

It should be noted that the use of particular terminology when describing certain features or embodiments of the disclosure should not be taken to imply that the terminology is being re-defined herein to be restricted to include any specific characteristics of the features or embodiments of the disclosure with which that terminology is associated. Terms and phrases used in this application, and variations thereof, especially in the appended claims, unless otherwise expressly stated, should be construed as open-ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least”; the term “such as” should be interpreted as “such as, without limitation”; the term “includes” should be interpreted as “includes but is not limited to”; the term “example” is used to provide exemplary instances of the item in discussion, not an exhaustive or limiting list thereof, and should be interpreted as “example, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise.

In addition, as used herein, the term “coupled” means connected to or joined to or placed into communication with, either directly or through intermediate components. The term “patient” is broadly defined herein to include human patients of all sizes, genders and demographics, as well as animals (e.g., for veterinarian purposes). The terminology includes the words noted above, derivatives thereof and words of similar import.

It will be appreciated by those skilled in the art that changes could be made to the embodiments described above without departing from the broad inventive concept thereof. For example, various mechanical and electrical connection elements and actuators may be used to achieve the disclosed function. It is understood, therefore, that this invention is not limited to the particular embodiments disclosed, but it is intended to cover modifications within the spirit and scope of the present invention as defined by the appended claims.

What is claimed is:

1. An arm board system for a surgery table, comprising:
an arm board configured to support an arm of a patient, the arm board comprising:
a first end,
a second end opposing the first end,
a distal side,
a proximal side opposing the distal side,
a top surface, and
a bottom surface opposing the top surface,
at least one first joint configured to allow the arm board to yaw,
at least one second joint configured to allow the arm board to vertically pitch, at least one third joint configured to allow the arm board to roll and horizontally translate,
a first controller H1 disposed along the bottom surface of the arm board and configured to actuate the at least one first joint and the at least one third joint, the first controller H1 comprising a first handle configured to actuate the first controller H1,
a second controller H2 disposed along the bottom surface of the arm board and configured to actuate the at least one second joint, the second controller H2 comprising a second handle configured to actuate the second controller H2,
wherein the first controller H1 is configured to be actuated by a first hand of a user and the second controller H2 is configured to be simultaneously actuated a second hand of the user,
a locking mechanism configured to alternately move between:
an unlocked position, in which the first controller H1 and the second controller H2 are uncoupled such that the first controller H1 and the second controller H2 do not form a unit, the locking mechanism in the unlocked position configured to allow actuation of the second controller H2, and
a locked position, in which the first controller H1 and the second controller H2 are coupled such that the first controller H1 and the second controller H2 form a unit, the locking mechanism in the locked position configured to prevent actuation of the second controller H2 until actuation of the first controller H1.

2. The arm board system of claim 1, wherein the locking mechanism is further configured to alternately allow and prevent the second handle from being actuated based on actuation of the first controller H1 by the first handle such that:
the second controller H2 is not actuatable in the locked position of the locking mechanism when the first handle is not actuated and does not actuate the first controller H1, and
the second controller H2 is actuatable in the unlocked position of the locking mechanism by the second handle when the first handle is actuated and actuates the first controller H1.

3. The arm board system of claim 2, wherein the bottom surface comprises a first edge and a second edge opposing the first edge,
wherein the first handle is disposed adjacent the first edge, and
wherein the second handle is disposed adjacent the second edge.

4. The arm board system of claim 1, wherein the first controller H1 and second controller H2 are configured to be pivoted.

5. The arm board system of claim 1, wherein the locking mechanism comprises a first link and a second link, and the first link coupled to the first controller H1 and the second link coupled to the second controller H2,
wherein the locking mechanism is configured to prevent actuation of the second controller H2 when the first link and the second link are coupled,
wherein actuation of the first controller H1 is configured to uncouple the first link and the second link, and
wherein the locking mechanism is configured to allow actuation of the second controller H2 when the first link and the second link are uncoupled.

6. The arm board system of claim 5, wherein the locking mechanism further comprises a latch hook coupled to the first link and a slam latch coupled to the second link,
wherein the latch hook and the slam latch are configured to be coupled to one another such that the first link and the second link are coupled,
wherein the latch hook is configured to uncouple from the slam latch when the first link is pulled,
wherein the first controller H1 is configured to pull the first link when actuated wherein the latch hook is configured to couple to slam latch when the first link is released, and
wherein the first controller H1 is configured to release the first link when unactuated.

7. The arm board system of claim 1, further comprising:
a first H1 control cable coupled to the first handle and the one or more first joints, the first control cable configured to unlock the one or more first joints configured to be actuated by the first controller H1.

8. The arm board system of claim 7, wherein the locking mechanism further comprises:
a handle linkage; and
a pulley block coupled to the handle linkage and the first H1 control cable,
wherein the first controller H1 is configured to rotate the handle linkage to move the pulley block and pull the first H1 control cable to unlock the one or more first joints,
wherein the pulley block comprises one or more pulleys, and
wherein the first H1 control cable is wrapped around the one or more pulleys such that the one or more pulleys is configured to pull the first H1 control cable when the one or more pulleys are moved with the pulley block.

9. The arm board system of claim 1, further comprising:
the second joint configured to allow the arm board to vertically pitch about an axis A2,
at least one fourth joint configured to allow the arm board to vertically pitch about an axis A4, and
wherein the second controller H2 is further configured to actuate the at least one fourth joint and the at least one second joint.

10. The arm board system of claim 9, further comprising:
a shoulder arm comprising a first end coupled to the at least one first joint and a second end coupled to the at least one fourth joint,
wherein the at least one fourth joint is configured to allow the first end of the shoulder arm to pitch relative to the second end of the shoulder arm such that the arm board vertically pitches.

11. The arm board system of claim 10, wherein the arm board and the at least one second joint are located distal to a distal plane of the shoulder arm, such that the arm board does not intersect the shoulder arm upon rotation of the arm board about the at least one second joint.

12. The arm board system of claim 10, wherein, when the arm board and the shoulder arm are pitched in opposite directions, the arm board and the shoulder arm do not intersect.

13. The arm board system of claim 1, wherein the first end, the second end, the distal side, and the proximal side define a footprint of the arm board, and
wherein the at least first joint is contained within the footprint of the arm board.

14. The arm board system of claim 1, wherein the at least one third joint is configured to allow the arm board to tuck such that the arm board is rotatable to about 90 degrees.

15. The arm board system of claim 1, wherein the first end, the second end, the distal side, and the proximal side define a footprint of the arm board, and
wherein the at least one first joint and the at least third joint are coupled together and contained within the footprint of the arm board to provide the yaw, roll, and horizontal translate degrees of freedom.

16. An arm board system for a surgery table, comprising:
an arm board configured to support an arm of a patient and to move in at least 2 degrees of freedom, the arm board comprising:
a longitudinal axis of the arm board,
a transverse axis of the arm board,
a distal side,
a proximal side opposing the distal side,
a top surface,
a bottom surface opposing the top surface,
a first end, and
a second end opposing the first end,
a first controller H1 disposed along the bottom surface and configured to control the arm board in at least 2 of the at least 3 degrees of freedom, the first controller H1 comprising a first handle configured to actuate the first controller H1;
a second controller H2 disposed along the bottom surface and configured to control the arm board in at least the other of the at least 3 degrees of freedom, the second controller H2 comprising a second handle configured to actuate the second controller H2; and
wherein the first controller H1 is configured to be actuated by a first hand of a user and the second controller H2 is configured to be simultaneously actuated a second hand of the user,
a locking mechanism configured to alternately actuate the second controller H2 and prevent actuation of the second controller H2 based on actuation of the first controller H1, the locking mechanism further configured to alternately allow and prevent the second handle from being actuated based on actuation of the first controller H1 by the first handle such that:
the second controller H2 is not actuatable when the first handle is not actuated and does not actuate the first controller H1, and
the second controller H2 is actuatable by the second handle when the first handle is actuated and actuates the first controller H1.

17. The arm board system of claim 16, further comprising:
a joint J1 coupled to the bottom surface of the arm board, the joint J1 comprising:
a rod coupled to the bottom surface of the arm board, the rod extending generally along the longitudinal axis of the arm board,
a rod mount comprising a rotational axis A1a generally parallel to the longitudinal axis of the arm board, the rod mount configured to:
receive the rod,
allow the arm board to traverse by selectively permitting the rod to traverse the rod mount, and
allow the arm board to roll on the rotational axis A1a by selectively permitting the rod to rotate inside of the rod mount from a first arm board position to one of a first side or a second side such that the arm board is on a different plane and oblique relative to the first arm board position, and
a rotational mount coupled to the rod mount, the rotational mount comprising a rotational axis A1b generally perpendicular to a plane parallel to the first arm board position, the rotational mount configured to allow the arm board to yaw on the rotational axis A1b by selectively permitting the arm board to rotate in a direction selected from a first direction or a second direction such that the arm board is on the same plane and oblique relative to the first arm board position,
wherein the first controller H1 is configured to actuate the joint J1.

18. The arm board system of claim 17 further comprising:
a joint J2 coupled to the joint J1, the joint J2 comprising a rotational axis A2 generally perpendicular to the rotational axis A1b of the rotational mount of the joint J1, and configured to allow the arm board to pitch on the rotational axis A2 from the first arm board position by selectively permitting the joint J2 to rotate in a direction selected from a frontwards direction and a backwards direction such that the arm board is on a different plane and oblique relative to the first arm board position,
a shoulder arm comprising a first end coupled to the joint J2, a second end, and a longitudinal axis generally perpendicular to the rotational axis A2 of the joint J2, and
a joint J4, the second end of the shoulder arm coupled to the joint J4, the joint J4 comprising a rotational axis A4 parallel to the rotational axis A2 of the joint J2, the joint J4 configured to allow the first end of the shoulder arm to pitch on the rotational axis A2 by selectively permitting the first end of the shoulder arm to rotate relative to the second end of the shoulder arm upwards or downwards such that shoulder arm is on a different plane and oblique relative to the first shoulder arm position,
wherein the second controller H2 is configured to actuate the joint J2 and the joint J4.

19. The arm board system of claim 18, further comprising:
a joint J3 coupled to the joint J4, the joint J3 comprising a rotational axis A3 parallel to the rotational axis A1b of the rotational mount of the joint J1, the joint J3 configured to allow the shoulder arm to yaw on the rotational axis A3 by selectively permitting the first end to rotate relative to the second end of the shoulder arm in a direction selected from a first direction or a second direction such that the shoulder arm is on the same plane and oblique relative to the first shoulder arm position
wherein the first controller H1 is configured to actuate the joint J3.

20. The arm board system of claim 19, the joint J3 further comprising a range of motion of approximately 90 degrees, the joint J3 configured to allow the arm board to tuck by selectively permitting the arm board to rotate from the first arm board position such that the arm board is generally perpendicular to the first arm board position.
